(19) United States
(12) Patent Application Publication
(10) Pub. No.: US 2011/0142113 A1
(43) Pub. Date: Jun. 16, 2011

(54) COMMUNICATION APPARATUS

(75) Inventors: Mitsuhiko HOKAZONO, Kanagawa (JP); Tetsuya Heima, Kanagawa (JP); Kazuaki Hori, Kanagawa (JP)

(73) Assignee: RENESAS ELECTRONICS CORPORATION

(21) Appl. No.: 12/963,385

(22) Filed: Dec. 8, 2010

(30) Foreign Application Priority Data
Dec. 11, 2009 (JP) 2009-281360

(51) Int. Cl. H04L 27/36; H04B 17/00

(52) U.S. Cl. 375/224; 375/298

(57) ABSTRACT

The present invention provides a communication apparatus (RFIC) capable of performing a DC offset correction of an orthogonal modulation unit with a degree of accuracy higher than conventional. The orthogonal modulation unit of the RFIC includes first and second mixers, an adder and first and second switches. The first mixer receives a first local oscillation signal therein through the first switch. The second mixer receives a second local oscillation signal therein through the second switch. During calibration, a DC offset of the first mixer is adjusted in a state in which the first switch is brought to an ON state and the second switch is brought to an OFF state. Further, a DC offset of the second mixer is adjusted in a state in which the first switch is brought to an OFF state and the second switch is brought to an ON state.

### CROSS-REFERENCE TO RELATED APPLICATIONS

The disclosure of Japanese Patent Application No. 2009-281360 filed on Dec. 11, 2009 including the specification, drawings and abstract is incorporated herein by reference in its entirety.

### BACKGROUND OF THE INVENTION

The present invention relates to a communication apparatus of such a system that a carrier wave is orthogonal-modulated by baseband signals (I and Q signals).

When a carrier signal (carrier wave) is transmitted a leak in a transmit signal where it is modulated by an RFIC (Radio Frequency Integrated Circuit) for communication equipment such as a cellular phone, the carrier signal becomes noise on the receiving side, thereby degrading an SN (Signal to Noise) ratio of a received signal. Reducing a leak (carrier leak) of a carrier signal in a modulator is thus essential. Therefore, there has heretofore been adopted a way of reducing a DC (direct current) offset between differential input terminals of the modulator, which is one cause of the carrier leak.

A transmitting device disclosed in, for example, Japanese Unexamined Patent Publication No. 2009-212869 (patent document 1) is equipped with a transmission modulator including a first modulator and a second modulator, a phase detector and a controller. A local signal and a second local signal respectively supplied to the first and second modulators are set to a predetermined phase difference (90°). During a calibration operation for reducing a carrier leak, the first local signal or the second local signal and a carrier signal that leaks in the output of the transmission modulator are supplied to the phase detector. The controller adjusts a DC bias current of each pair transistor that configures each modulator, until the phase detector detects the predetermined phase difference (90°).

A carrier leak adjustment device disclosed in Japanese Unexamined Patent Publication No. 2006-41631 (patent document 2) includes a contact point A provided on an I channel line of a quadrature or orthogonal modulator, a contact point B provided on a Q channel line thereof, and a contact point C provide at an output terminal of a detector for detecting an output signal level of the orthogonal modulator. The carrier leak adjustment device has a switch. The carrier leak adjustment device first couples the switch to the contact points A and B in order to acquire DC offset correction values for I and Q channels. Next, the carrier leak adjustment device couples the switch to the contact point C to detect the amount of carrier leak and searches for a carrier leak-minimized correction value out of correction value candidates in a predetermined range based on the previously-acquired DC offset correction values.

Japanese Unexamined Patent Publication No. 2007-208380 (patent document 3) discloses a method wherein in a wireless communication device which executes orthogonal modulation in accordance with a direct RF (Radio Frequency) modulation system, the correction of each DC offset can be carried out correctly even when unmodulated signals are transmitted for frequency confirmation. To describe concretely, when the unmodulated signals are transmitted, they are sent while being sequentially changed in phase. A DC offset correction is performed using an integral value of a feedback signal of each transmitted unmodulated signal.

In a transmitting device disclosed in Japanese Unexamined Patent Publication No. 2004-221653 (patent document 4), the value of RSSI (Received Signal Strength Indicator) of a modulated signal outputted from an orthogonal modulation circuit is detected. The level of a DC offset correction signal having I-phase and Q-phase components is adjusted in such a manner that the detected value of RSSI becomes small.

In a transmitting device disclosed in Japanese Unexamined Patent Publication No. 2003-125014 (patent document 5), a DC offset is adjusted with respect to each analog differential signal inputted to an orthogonal modulator. To describe specifically, digital I and Q signals are first generated by an I/Q signal generator. The I and Q signals are converted into analog form, followed by generation of signals I+, I−, Q+ and Q− (analog differential signals) different in phase from one another by 180° by means of an U/B (Unbalance/Balance) converter, which in turn are applied to the orthogonal modulator. In order to minimize a carrier leak of the orthogonal modulator, DC offset values of Vi+ and Vq+ (or Vi− and Vq−) are respectively applied to signal lines of I+ and Q+ (or I− and Q−) in such a manner that the carrier leak becomes a minimum, based on a level-detected value of an output signal of the orthogonal modulator when the I and Q signals are not outputted from the I/Q signal generator.

Miyashita et al. have disclosed a DC offset correction device in a transmitter of a Low-IF (Intermediate Frequency) system (refer to “A Low-IF CMOS Single-Chip Bluetooth EDR Transmitter with Digital I/Q Mismatch Trimming Circuit”, 2005 Symposium on VLSI Circuits Digest of Technical Papers, p. 298-301 (non-patent document 1)). The DC offset correction device described in this patent document stops a voltage-controlled oscillator during a calibration period. In this condition, a power supply voltage is applied to a +side input terminal (LOi+) to which a local oscillation signal for an I signal is inputted, and input terminals (LOi−, LOq+ and LOq−) for other local oscillation signals are grounded. A DC offset of an I channel is detected by the output of a mixer circuit at this time. Likewise, a DC offset of a Q channel is also detected.

Also as to a receiving device, a carrier leak of an orthogonal modulator becomes a problem associated with signal processing in a manner similar to the transmitting device. In a communication apparatus disclosed in Japanese Unexamined Patent Publication No. 2001-245006 (patent document 6), there is disclosed a method capable of eliminating each DC offset voltage even when it receives a wireless signal at which available slots cannot be ensured because a plurality of reception slots lying in one frame are used. To describe concretely, a DC offset voltage developed in a baseband signal is detected at a first timing set to a guard interval prior to a data signal interval in each reception slot. It is determined at a second timing subsequent to the first timing whether the detected DC offset voltage falls within a predetermined range. The DC offset voltage is adjusted at a third timing set to a guard interval after a data signal interval, based on the above result of determination.

### SUMMARY OF THE INVENTION

A problem arises in that the accuracy of correction is not enough for a conventional DC offset correcting method. It is therefore necessary for the conventional method to ensure the accuracy of correction by performing offset correction for I and Q signals by plural times respectively. The conventional method took time for the offset correction. In the case of a cellular phone in particular, an offset correcting operation is performed every time before its transmitting/receiving operation is started. The necessity to set the time required for the offset correction as short as possible is therefore great.

Generally, as the output power of a power amplifier becomes small, the signal level of a carrier leak with respect to the signal level of a transmit signal becomes relatively large. There is therefore a need to build in, for example, such a mechanism that the amplitude of a local oscillation signal is reduced as an output voltage of a power amplifier becomes small, for the purpose of ensuring an SN ratio of the transmit signal in a state in which a DC offset correction having sufficient accuracy is not performed. Incorporating such a mechanism into a local oscillator is, however, difficult because an apparatus configuration increases in complexity.

An object of the present invention is to provide a communication apparatus capable of performing a DC offset correction of an orthogonal modulation unit with a degree of accuracy higher than conventional.

A communication apparatus according to one embodiment of the present invention has a transmission mode and a calibration mode as operation modes. The communication apparatus comprises a local signal generation unit, first and second switches, first and second mixers, an adder, and a controller. The local signal generation unit generates first and second local oscillation signals different in phase from each other by 90°. The first switch receives the first local oscillation signal therein and outputs the first local oscillation signal when a first control signal is activated. The second switch receives the second local oscillation signal therein and outputs the second local oscillation signal when a second control signal is activated. The first mixer has a first input unit, and multiplies a signal inputted to the first input unit and the ac signal component outputted from the first switch by each other and outputs a result of multiplication therefrom. The second mixer has a second input unit, and multiplies a signal inputted to the second input unit and the ac signal component outputted from the second switch by each other and outputs a result of multiplication therefrom. The first input unit is inputted with a first offset correction signal under adjustment in the calibration mode, and inputted with a first baseband signal added with the post-adjustment first offset correction signal in the transmission mode. The second input unit is inputted with a second offset correction signal under adjustment in the calibration mode, and inputted with a second baseband signal added with the post-adjustment second offset correction signal in the transmission mode. The adder adds the ac signal components outputted from the first and second mixers and outputs a result of addition therefrom. The controller outputs the first and second control signals and adjusts the first and second offset correction signals, based on the output signal of the adder in the calibration mode. The controller activates at least one of the first and second control signals in the calibration mode.

According to the above embodiment, the first offset correction signal can be adjusted in the calibration mode, based on the signal obtained by mixing the first offset correction signal and the first local oscillation signal with each other. The second offset correction signal can be adjusted in the calibration mode, based on the signal obtained by mixing the second offset correction signal and the second local oscillation signal with each other. It is thus possible to perform a DC offset correction of an orthogonal modulation unit with a degree of accuracy higher than conventional.

### BRIEF DESCRIPTION OF THE DRAWINGS

FIG. 1 is a block diagram showing an overall configuration of a communication apparatus 1 using an RFIC 10 according to a first embodiment of the present invention;

FIG. 2 is a block diagram illustrating a portion related to a DC offset correction of an orthogonal modulation unit 30 in the RFIC 10 shown in FIG. 1;

FIG. 3 is a diagram typically showing waveforms of local oscillation signals and carrier leak signals inputted to a phase detector 41 of FIG. 2 during calibration;

FIG. 4 is a diagram illustrating a relationship between offset voltages Vi and Vq of the orthogonal modulation unit 30 and output voltages VPDi and VPq of the phase detector 41 (where switches SW1 and SW2 are not changed over);

FIG. 5 is a diagram for describing an offset correcting operation where the switches SW1 and SW2 is are not changed over;

FIG. 6 is a diagram showing a relationship between an amount of carrier leak and each output voltage of the phase detector 41 (PD) in FIG. 5;

FIG. 7 is a diagram for explaining an offset correcting operation where the switches SW1 and SW2 are changed over;

FIG. 8 is a diagram illustrating a relationship between an amount of carrier leak and each output voltage of the phase detector 41 (PD) in FIG. 7;

FIG. 9 is a timing diagram showing a procedure for DC offset correction by a controller 12 shown in FIG. 2;

FIG. 10 is a flowchart showing the procedure for the DC offset correction by the controller 12 shown in FIG. 2;

FIG. 11 is a diagram for explaining timings for DC offset correction where the RFIC 10 of FIG. 2 is applied to a cellular phone;

FIG. 12 is a circuit diagram showing one example of a configuration illustrative of the switches SW1 and SW2 shown in FIG. 2;

FIG. 13 is a circuit diagram illustrating one example of a configuration of a portion excepting the switches SW1 and SW2 of the orthogonal modulation unit 30 shown in FIG. 2;

FIG. 14 is a circuit diagram illustrating one example of a configuration of a selector 40 shown in FIG. 2;

FIG. 15 is a circuit diagram depicting one example of a configuration of the phase detector 41 and a comparator 42 shown in FIG. 2;

FIG. 16 is a block diagram showing a portion related to a DC offset correction, of an RFIC 10A according to a modification of the first embodiment of the present invention;

FIG. 17 is a timing diagram showing a procedure for DC offset correction according to a second embodiment of the present invention;

FIG. 18 is a flowchart illustrating the procedure for the DC offset correction according to the second embodiment of the present invention;

FIG. 19 is a block diagram showing a portion related to a DC offset correction, of an RFIC 10B according to a third embodiment of the present invention;

FIG. 20 is a circuit diagram illustrating one example of a configuration of an orthogonal modulation unit 30A shown in FIG. 19;

FIG. 21 is a block diagram showing a portion related to a DC offset correction, of an RFIC 10C according to a fourth embodiment of the present invention;

FIG. 22 is a circuit diagram illustrating one example of a configuration of an orthogonal modulation unit 30B shown in FIG. 21; and

FIG. 23 is a block diagram showing a portion related to a DC offset correction, of an RFIC 10D according to a fifth embodiment of the present invention.

### DETAILED DESCRIPTION OF THE PREFERRED EMBODIMENTS

Preferred embodiments of the present invention will hereinafter be described in detail with reference to the accompanying drawings. Incidentally, the same or corresponding parts are respectively identified by the same reference numerals, and their explanations will not be repeated.

### First Embodiment

### Overall Configuration of Communication Apparatus 1

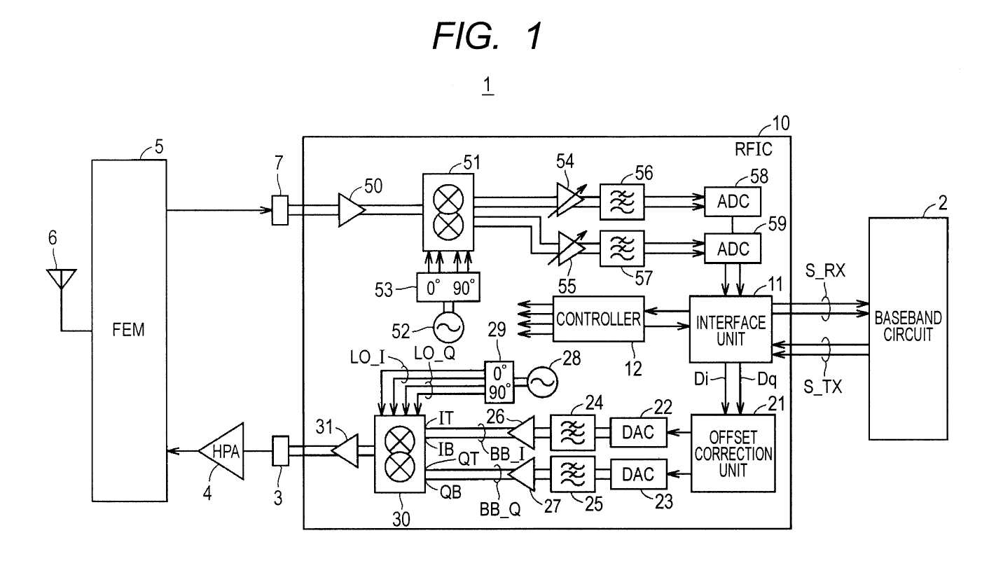

FIG. 1 is a block diagram showing an overall configuration of a communication apparatus 1 using an RFIC 10 according to a first embodiment of the present invention. Referring to FIG. 1, the communication apparatus 1 includes a baseband circuit 2, the RFIC 10 (communication device), a converter 3 which converts a differential signal to a single end signal, a high power amplifier 4 (HPA), a front-end module 5 (FEM), an antenna element 6, and a converter 7 which converts the single end signal to its corresponding differential signal. The operations of the respective parts of the communication apparatus 1 will hereinafter be briefly explained in parts at transmission and reception.

At transmission, the baseband circuit 2 generates an I signal corresponding to an in-phase signal and a Q signal corresponding to an orthogonal or quadrature phase component, based on transmission data. The so-generated I and Q signals are once converted to an LVDS (Low Voltage Differential Signaling)-spec serial differential signal S_TX, which in turn is outputted to the RFIC 10. The serial differential signal S_TX is serial-to-parallel converted by an interface unit 11 of the RFIC 10 to generate an I signal Di and a Q signal Dq corresponding to parallel signals.

The RFIC 10 includes, as a configuration of a transmitting device, an offset correction unit 21, digital-to-analog converters 22 and 23 (DAC), low-pass filters 24 and 25, amplifiers 26 and 27, a local oscillator 28, a phase shifter 29, an orthogonal modulation unit 30, and a high-frequency programmable gain amplifier 31 (PGA).

First and second offset correction values are respectively added to the digital I and Q signals Di and Dq outputted from the interface unit 11 by the offset correction unit 21. The offset correction values are used to suppress a carrier leak of the orthogonal modulation unit 30 and their values are determined in a calibration mode.

The digital-to-analog converters 22 and 23 respectively convert the offset-corrected I and Q signals Di and Dq into analog differential signals. The post-offset correction I and Q signals subjected to the analog conversion respectively pass through the low-pass filters 24 and 25, followed by being level-adjusted by the amplifiers 26 and 27 respectively. Thereafter, the post-offset correction I signal (baseband signal) is inputted to differential input terminals IT and IB (first input part) of the orthogonal modulation unit 30, whereas the post-offset correction Q signal (baseband signal) is inputted to differential input terminals QT and QB (second input part) of the orthogonal modulation unit 30. In FIG. 1, the I signal inputted to the orthogonal modulation unit 30 is described as BB_I and the Q signal inputted thereto is described as BB_Q. When a distinction is made between a non-inversion signal and an inverse signal that configure each differential signal, T (non-inverse signal) and B (inverse signal) are respectively appended to the ends of reference numerals and described like I signals BB_IT and BB_IB and Q signals BB_QT and BB_QB.

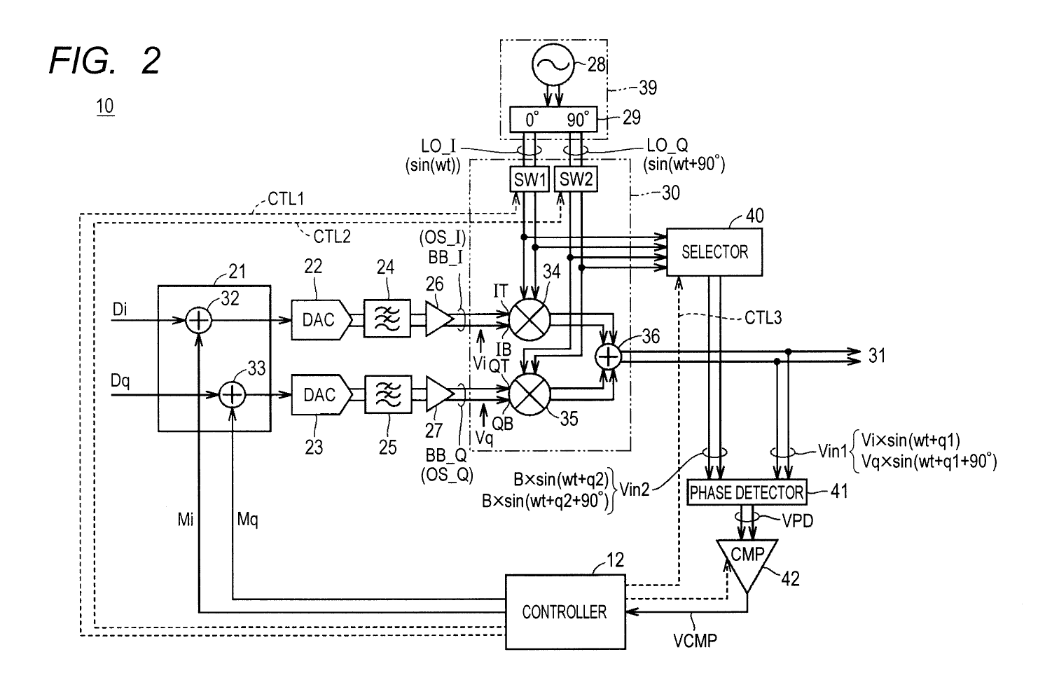

The orthogonal modulation unit 30 further receives therein a first local oscillation signal LO_I outputted from the local oscillator 28 and a second local oscillation signal LO_Q obtained by allowing the phase shifter 29 to phase-shift the first local oscillation signal LO_I by 90°. The local oscillation signals LO_I and LO_Q indicate analog differential signals. When a distinction is made between a non-inversion signal and an inverse signal, T (non-inverse signal) and B (inverse signal) are respectively appended to the ends of reference numerals and described like first local oscillation signals LO_IT and LO_IB and second local oscillation signals LO_QT and LO_QB. In a transmission mode, the orthogonal modulation unit 30 adds a signal obtained by mixing the I signal BB_I and the first local oscillation signal LO_I with each other and a signal obtained by mixing the Q signal BB_Q and the second local oscillation signal LO_Q with each other to thereby generate a transmit signal. A more detailed configuration of the orthogonal modulation unit 30 will be explained later with reference to FIG. 2. The high-frequency transmit signal generated by the orthogonal modulation unit 30 is level-adjusted by the programmable gain amplifier 31, after which it is converted from a differential signal to a single end signal by the converter 3.

The high power amplifier 4 amplifies the transmit signal outputted from the converter 3. The amplified transmit signal is supplied to the antenna element 6 by the front-end module 5 and radiated through the antenna element 6. The front-end module 5 is a switch which performs switching for coupling to the antenna element at transmission and reception.

Next, a signal received by the antenna element 6 is inputted to the converter 7 by the front-end module 5 during reception. The converter 7 converts the received signal corresponding to the single end signal into a differential signal and outputs it to the RFIC 10.

The RFIC 10 includes, as a configuration of a receiving device, a low noise amplifier 50, an orthogonal demodulation unit 51, a local oscillator 52, a phase shifter 53, programmable gain amplifiers 54 and 55, low-pass filters 56 and 57, and analog-to-digital converters 58 and 59 (ADC).

The received signal outputted from the converter 7 is amplified by the low noise amplifier 50, followed by being input to the orthogonal demodulation unit 51. The orthogonal demodulation unit 51 receives therein a first local oscillation signal outputted from the local oscillator 52 and a second local oscillation signal obtained by allowing the phase shifter 53 to phase-shift the first local oscillation signal by 90°, in addition to the received signal. The orthogonal demodulation unit 51 mixes the received signal and the first local oscillation signal together to thereby generate an I signal and mixes the received signal and the second local oscillation signal together to thereby generate a Q signal.

The I and Q signals generated by the orthogonal demodulation unit 51 are respectively level-adjusted by the programmable gain amplifiers 54 and 55, followed by being inputted to the low-pass filters 56 and 57 respectively. The I and Q signals having passed through the low-pass filters 56 and 57 are digitally converted by the analog-to-digital converters 58 and 59 respectively. Thereafter, the I and Q signals are converted into an LVDS-spec serial differential signal S_RX, which in turn is outputted to the baseband circuit 2. The baseband circuit 2 demodulates the received data, based on the I and Q signals received as the serial differential signal S_RX.

The RFIC 10 further includes a controller 12. The controller 12 controls the respective elements of the above transmitting and receiving devices.

### [Details of DC Offset Correction]

FIG. 2 is a block diagram showing in further detail, a portion related to the DC offset correction of the orthogonal modulation unit 30 in the RFIC 10 shown in FIG. 1. The RFIC 10 further includes a selector 40, a phase detector 41 (PD) and a comparator 42 (CMP) in addition to the already-described controller 12, offset correction unit 21, digital-to-analog converters 22 and 23, low-pass filters 24 and 25, amplifiers 26 and 27, orthogonal modulation unit 30, local oscillator 28 and phase shifter 29. Further detailed configurations of the orthogonal modulation unit 30 and the offset correction unit 21 are also shown in FIG. 2. Incidentally, the local oscillator 28 and the phase shifter 29 are referred to as a local signal generation unit 39 in conjunction with each other.

### (1. Cause of Carrier Leak and Meaning of DC Offset Correction)

A configuration of the orthogonal modulation unit 30 and a DC offset being a principal factor of a carrier leak will first be explained.

As shown in FIG. 2, the orthogonal modulation unit 30 includes first and second mixers 34 and 35 (mixers/multipliers), an adder 36, and first and second switches SW1 and SW2. At transmission, the switches SW1 and SW2 are both controlled to be an ON state. At this time, the first mixer 34 mixes an I signal BB_I (the amount of correction by the offset correction unit 21 is assumed to be 0) inputted to the differential input terminals IT and IB (first input part), and a first local oscillation signal LO_I with each other. The second mixer 35 mixes a Q signal BB_Q (the amount of correction by the offset correction unit 21 is assumed to be 0) inputted to the differential input terminals QT and QB (second input part), and a second local oscillation signal LO_Q with each other. The adder 36 adds an ac signal outputted from the first mixer 34 and an ac signal outputted from the second mixer 35 to thereby generate a transmit signal. The first and second mixers 34 and 35 can respectively be configured by, for example, a Gilbert cell circuit.

Now, as shown in FIG. 2, the first local oscillation signal LO_I is assumed to be sin(w×t), and the I signal BB_I is assumed to be sin(u×t+q0). However, the angular frequency of the first local oscillation signal LO_I is expressed in w, the angular frequency and initial phase of the I signal BB_I are respectively expressed in u and q0, and the time is expressed in t. In doing so, the output signal of the mixer 34 is represented in the form of sin(wt)×sin(ut+q0)=−[cos((w+u)t+q0)−cos((w−u)t−q0)]/2 . . . (1). Namely, the angular frequency of the transmit signal outputted from the orthogonal modulation unit 30 assumes w+u and w−u.

When, however, a DC offset Vi is included between the input terminals IT and IB for the I signal BB_I, of the mixer 34, a carrier leak component of an angular frequency w, which is represented in the form of Vi×sin(wt) . . . (2), exists in the output signal of the mixer 34 in mixed form. The DC offset Vi in this case occurs due to variations in wiring parasitic resistance and elements from the digital-to-analog converter 22 to the input terminals IT and IB of the mixer 34. The carrier leak component becomes noise of the transmit signal and degrades an SN ratio.

When a DC offset Vq is included between the input terminals QT and QB for the Q signal BB_Q, of the mixer 35 assuming the second local oscillation signal LO_Q as sin(w×t+90°) with respect to the Q signal side as well, a carrier leak component of an angular frequency w, which is represented in the form of Vq×sin(wt+90°) . . . (3), exists in the output signal of the mixer 35 in mixed form. The carrier leak component also becomes noise of the transmit signal and degrades an SN ratio.

The carrier leaks of the outputs of the mixers 34 and 35 become minimum when the DC offsets Vi and Vq are 0, but inevitably occur due to variations in wiring parasitic resistance and elements. Therefore, in order to cancel the DC offsets Vi and Vq, the RFIC 10 is provided with the offset correction unit 21. The offset correction unit 21 includes adders 32 and 33, which respectively add offset correction values Mi and Mq to the digital I and Q signals Di and Dq in such a manner that voltages of −Vi and −Vq are respectively applied between the input terminals of the mixers 34 and 35.

### (2. Outline of Components Related to DC Offset Correction)

The offset correction values Mi and Mq are adjusted during calibration prior to data transmission. During the calibration, the baseband circuit 2 shown in FIG. 1 does not output the I and Q signals Di and Dq via the interface unit 11. Accordingly, only DC offset correction signals OS_I and OS_Q obtained by converting the offset correction values Mi and Mq into analog form are inputted to the differential input terminals of the orthogonal modulation unit 30.

The controller 12 monitors the output signal of the orthogonal modulation unit 30 while changing the offset correction values Mi and Mq, i.e., changing the DC offset correction signal OS_I and OS_Q. The controller 12 determines such offset correction values Mi and Mq that the amount of carrier leak becomes a minimum, based on the monitored output signal. In order to perform this offset correction, the RFIC 10 is provided with the selector 40, phase detector 41 and comparator 42. Further, the orthogonal modulation unit 30 is provided with the switches SW1 and SW2.

The selector 40 receives the first local oscillation signal LO_I and the second local oscillation signal LO_Q therein and selects and outputs one thereof in accordance with a control signal CTL3 outputted from the controller 12 during calibration. The controller 12 allows the first local oscillation signal LO_I to be outputted from the selector 40 when the offset correction value Mi corresponding to the I signal Di is adjusted, and allows the second local oscillation signal LO_Q to be outputted from the selector 40 when the offset correction value Mq corresponding to the Q signal Dq is adjusted.

The phase detector 41 compares the phase of the output signal of the orthogonal modulation unit 30 and the phase of the output signal of the selector 40 and outputs a signal corresponding to the difference in phase therebetween. In the case of the first embodiment, the phase detector 41 is comprised of a multiplier and a low-pass filter and outputs 0 when the detected phase difference is 90°.

The comparator 42 compares the output of the phase detector 41 and a predetermined reference value in accordance with a timing signal outputted from the controller 12 and outputs a high (H) or low (L) logic level signal to the controller 12 according to the result of comparison. In the case of the first embodiment, the comparator 42 outputs an H level signal when the output of the phase detector 41 is a positive value, and outputs an L level signal when the output thereof is a negative value. The controller 12 increases or decreases the offset correction value Mi or Mq in accordance with an output voltage VCMP of the comparator 42 and finally sets the offset correction value Mi or Mq at the time that the output of the phase detector 41 changes from the positive value to the negative value or vice versa, as an offset correction value used at transmission.

The first switch SW1 is provided on a transmission path for the first local oscillation signal LO_I, lying between the local signal generation unit 39 and the first mixer 34. When a control signal CTL1 outputted from the controller 12 is activated, the first switch SW1 is brought to an ON state, whereas when the control signal CTL1 is inactivated, the first switch SW1 is brought to an OFF state. The second switch SW2 is provided on a transmission path for the second local oscillation signal, lying between the local signal generation unit 39 and the second mixer 35. When a control signal CTL2 outputted from the controller 12 is activated, the second switch SW2 is brought to an ON state, whereas when the control signal CTL2 is inactivated, the second switch SW2 is changed over to an OFF state.

The switches SW1 and SW2 are both controlled to be an ON state at transmission. On the other hand, in the case of the first embodiment, the controller 12 brings the first switch SW1 to an ON state and brings the second switch SW2 to an OFF state during calibration of the first offset correction value Mi. As a result, since the ac signal outputted from the second mixer 35 becomes 0, the signal obtained by mixing the first DC offset correction signal OS_I and the first local oscillation signal LO_I by the first mixer 34 is outputted from the adder 36. Incidentally, the second switch SW2 may desirably be configured in such a manner that when the second switch SW2 is in the OFF state, its output becomes a voltage corresponding to a fixed voltage (e.g., a power supply voltage VDD level). During calibration of the second offset correction value Mq, the controller 12 brings the first switch SW1 to an OFF state and brings the second switch SW2 to an ON state. As a result, since the ac signal outputted from the first mixer 34 becomes 0, the signal obtained by mixing the second DC offset correction signal OS_Q and the second local oscillation signal LO_Q by the second mixer 35 is outputted from the adder 36. Incidentally, the first switch SW1 may desirably be configured in such a manner that when the first switch SW1 is in the OFF state, its output becomes a voltage corresponding to the fixed voltage (e.g., the power supply voltage VDD level).

Changing over the switches SW1 and SW2 during calibration as described above makes it possible to enhance the accuracy of the DC offset correction. This reason will next be explained while comparing with the case in which the switches SW1 and SW2 are not changed over.

(3. Problems Associated with the Case where No Switches SW1 and SW2 are Changed Over)

All of the I signal Di, the Q signal Dq and the offset correction values Mi and Mq are assumed to be 0 below. When the switches SW1 and SW2 are always in an ON state, a carrier leak due to a DC offset Vi between the differential input terminals IT and IB and a carrier leak due to a DC offset Vq between the differential input terminals QT and QB are inputted to the phase detector 41 as a first input signal Vin1. Namely, the first input signal Vin1 is represented as Vin1=Vi×sin(wt+q1)+Vq×sin(wt+q1+90°) . . . (4). q1 in the above equation indicates a phase caused due to delays of the mixers 34 and 35, the adder 36 and wirings or the like. A local oscillation signal LO_I or LO_Q selected by the selector 40 is further inputted to the phase detector 41 as a second input signal Vin2. The second input signal Vin2 is represented as Vin2=B×sin(wt+q2) . . . (5) in the case of the local oscillation signal LO_I, whereas in the case of the local oscillation signal LO_Q, the second input signal Vin2 is represented as Vin2=B×sin(wt+q2+)90° . . . (6). q2 in each of the equations (5) and (6) indicates a phase produced due to delays of the selector 40 and wirings or the like, and B indicates the gain of the selector 40.

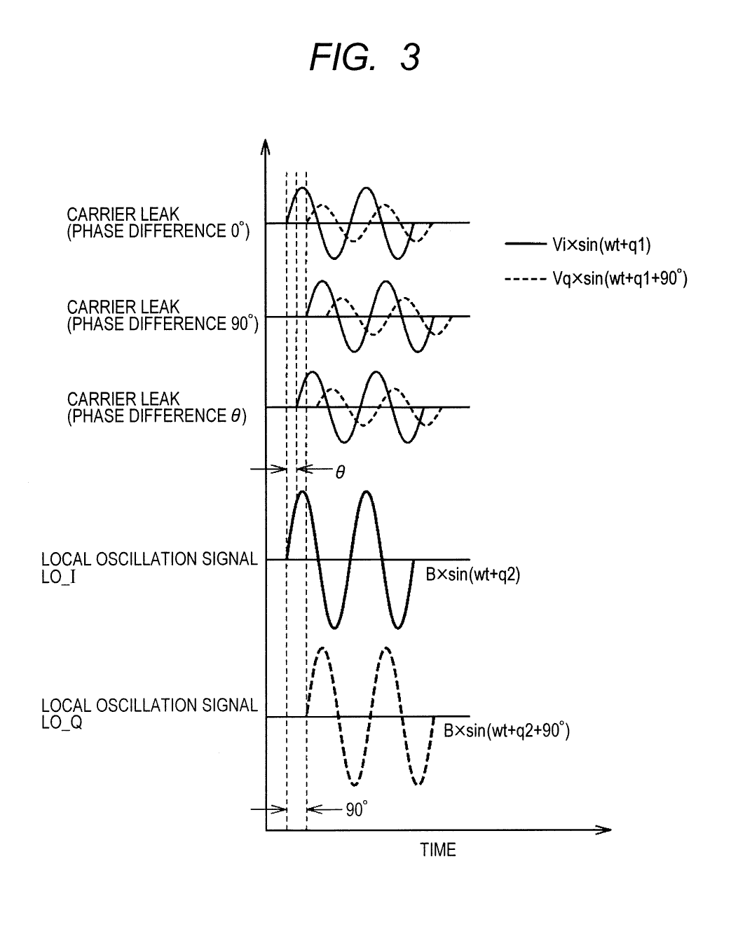

FIG. 3 is a diagram typically showing waveforms of local oscillation signals and carrier leak signals inputted to the phase detector 41 shown in FIG. 2 during calibration. As shown in FIG. 3, the phase q2 of the local oscillation signals LO_I and LO_Q and the phase q1 of each carrier leak signal normally differ from each other at the input terminals of the phase detector 41 as shown in FIG. 3. Here, a difference θ between the two is assumed to be θ=q1−q2 . . . (7). FIG. 3 shows carrier leak signals where the phase difference is 0°, the phase difference is greater than 0° and smaller than 90°, and the phase difference is 90°.

Assuming that the phase detector 41 is configured by the multiplier and the low-pass filter, the phase detector 41 outputs a dc component of a signal obtained by multiplying the first input signal Vin1 and the second input signal Vin2 by each other. When the local oscillation signal LO_I is selected by the selector 40, an output voltage VPDi of the phase detector 41 is represented as VPDi=B×C/2×[Vi×cos(q1−q2)+Vq×cos(q1−q2+90°)]=B×C/2×[Vi×cos θ−Vq×sin θ] . . . (8) by multiplying the right side of the equation (4) and the right side of the equation (5) by each other, where the gain of the phase detector 41 is assumed to be C. The term of an angular frequency 2×w also occurs in the calculation of the above equation (8), but is eliminated by the low-pass filter. Similarly, when the local oscillation signal LO_Q is selected by the selector 40, an output voltage VPDq of the phase detector 41 is represented as VPDq=B×C/2×[Vi×cos(q1−q2−90°)+Vq×cos(q1−q2)]=B×C/2×[Vi×sin θ+Vq×cos θ] . . . (9) by multiplying the right side of the equation (4) and the right side of the equation (6) by each other. When the above equations (8) and (9) are written using a determinant here, they can be represented using a rotation matrix as follows:

$$[ \begin{matrix}VPDi \\ VPDq\end{matrix} ] = \frac{B \times C}{2} ( \begin{matrix}cos θ & - sin θ \\ sin θ & cos θ\end{matrix} ) [ \begin{matrix}Vi \\ Vq\end{matrix} ] \qquad ( 10 )$$

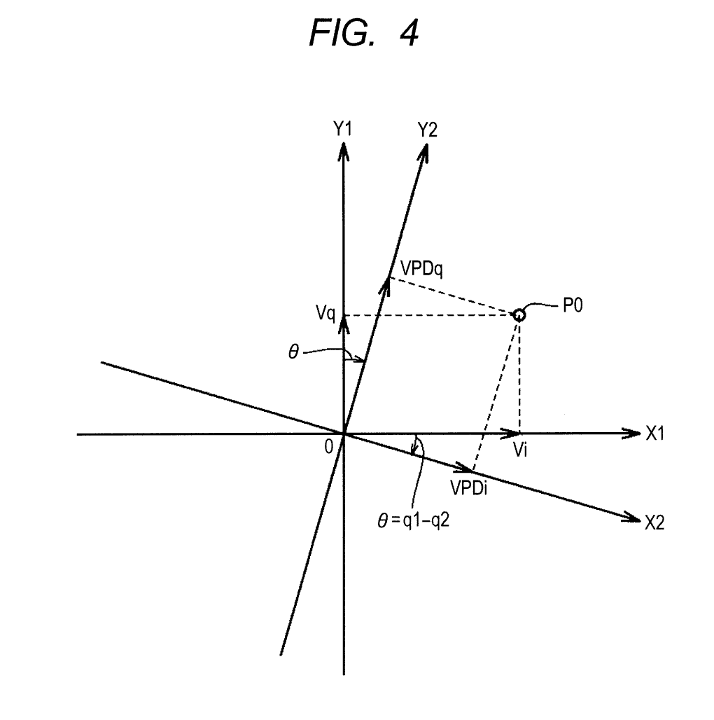

FIG. 4 is a diagram showing a relationship between the DC offset voltages Vi and Vq of the orthogonal modulation unit 30 and the output voltages VPDi and VPDq of the phase detector 41. FIG. 4 is equivalent to one in which the DC offset voltages Vi and Vq are represented by a point P0 (Vi, Vq) on an X1-Y1 coordinate plane, and the output voltages VPDi and VPDq of the phase detector 41 are represented by a point (VPDi, VPDq) on an X2-Y2 coordinate plane. In FIG. 4, the equation (10) is represented as B×C/2=1 for the sake of simplicity. The DC offset voltages (Vi and Vq) are converted into the output voltages (VPDi and VPDq) of the phase detector 41 by rotating the coordinate axis by θ clockwise as shown in FIG. 4.

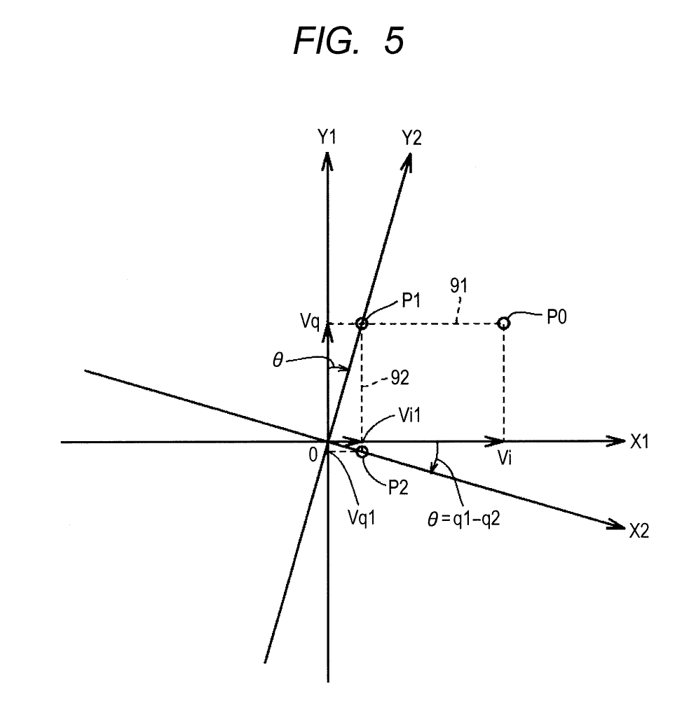

FIG. 5 is a diagram for explaining an offset correcting operation where no switches SW1 and SW2 are changed over. Referring to FIGS. 2 and 5, the offset correction values Mi and Mq are both 0 in an initial state at the calibration, and the DC offset voltages at this time are assumed to be Vi and Vq.

Firstly, the controller 12 allows the selector 40 to input the local oscillation signal LO_I to the phase detector 41. When the offset correction value Mi is adjusted in this state, the DC offset voltage V remains constant and only the DC offset voltage V1 changes. The point (Vi, Vq) indicative of the DC offset voltages moves along a straight line 91 from the point P0 on a coordinate plane of FIG. 5.

When the point (Vi, Vq) indicative of the DC offset voltages reaches a point P1 intersecting a coordinate axis Y2 in FIG. 5, the output voltage of the phase detector 41 is changed from positive to negative. Thus, the controller 12 fixes the offset correction value Mi at the point P1 and then allows the selector 40 to input the local oscillation signal LO_Q to the phase detector 41. When the offset correction value Mq is adjusted in this state, the DC offset voltage Vi remains constant and only the DC offset voltage Vq changes. The point (Vi, Vq) indicative of the DC offset voltages moves along a straight line 92 from the point P1 on the coordinate plane of FIG. 5.

When the point indicative of the DC offset voltages reaches a point P2 intersecting a coordinate axis X2 in FIG. 5, the output voltage of the phase detector 41 is changed from positive to negative. Thus, the controller 12 fixes the offset correction value Mq at this point P2. Since a DC offset Vil remains between the differential input terminals IT and IB at the point P2, and a DC offset Vq1 remains between the differential input terminals QT and QB at the point P2 as shown in FIG. 5, no carrier leak reaches 0. Therefore, the DC offset voltages Vi and Vq are allowed to approach zero as much as possible by repeating a similar procedure two or three times.

Thus, since the accuracy of DC offset correction is not enough where the switches SW1 and SW2 are not changed over, an adjustment in DC offset on the I signal side and an adjustment in DC offset on the Q signal side were required to be repeated two or three times in order to reduce the carrier leak as small as possible.

Incidentally, when the phase difference θ=q1−q2 becomes 0, the coordinate axis X1 and the coordinate axis X2 coincide with each other and the coordinate axis Y1 and the coordinate axis Y2 coincide with each other in FIG. 5. Accordingly, one adjustment in DC offset on the I signal side and one adjustment in DC offset on the Q signal side make it possible to adjust the carrier leaks to approximately 0. Since the phase q1 of the signal Vin1 inputted to the phase detector 41 and the phase q2 of the signal Vin2 inputted thereto do not normally coincide with each other, it is considered that the accuracy of offset correction has been degraded.

When the phase difference θ=q1−q2 becomes 90° or −90°, the coordinate axis X1 and the coordinate axis Y2 coincide with each other, and the coordinate axis Y1 and the coordinate axis Y2 coincide with each other in FIG. 5. Since, in this case, the straight line 91 shown in FIG. 5 becomes parallel to the coordinate axis Y2 and the straight line 92 becomes parallel to the coordinate axis X2, the DC offset correction cannot be performed in the above procedure.

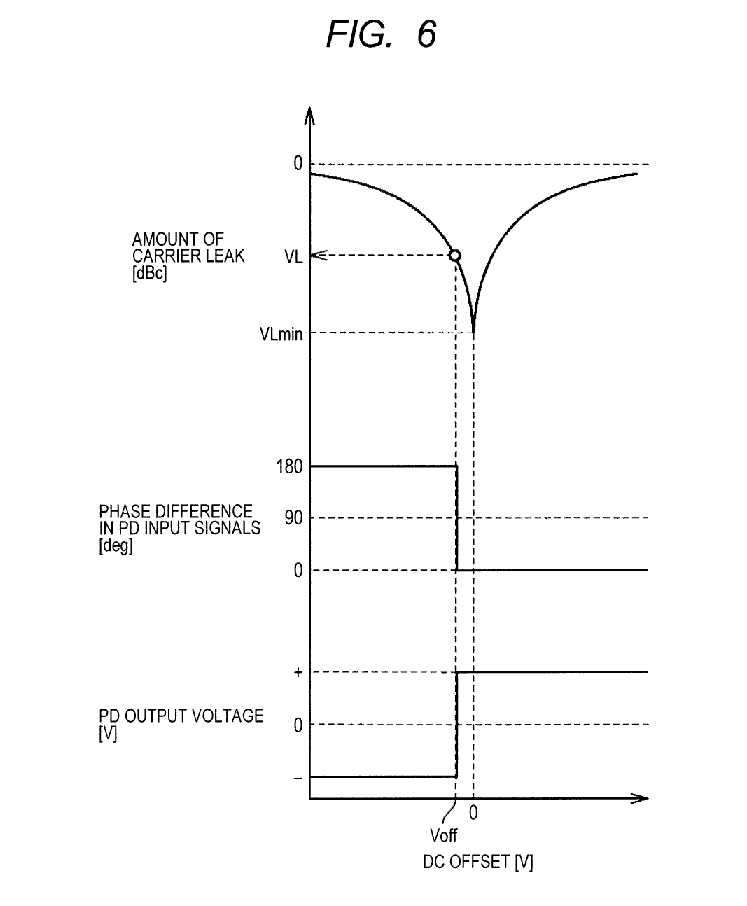

FIG. 6 is a diagram showing a relationship between the amount of carrier leak and each output voltage of the phase detector 41 (PD) in FIG. 5. When the DC offset voltage between the differential input terminals of the orthogonal modulation unit 30 is 0 as shown in FIG. 6, the carrier leak amount becomes a minimum value VLmin. When the switches SW1 and SW2 are not changed over, however, the output of the phase detector 41 is changed from negative to positive or vice versa where the DC offset voltage assumes a value Voff other than 0. The carrier leak amount VL becomes a value larger than the minimum value VLmin. Incidentally, when the output voltage of the phase detector 41 is changed from negative to positive or vice verse, the difference in phase between the input signals of the phase detector 41 is changed 180°.

### (4. When the Switches SW1 and SW2 are Changed Over)

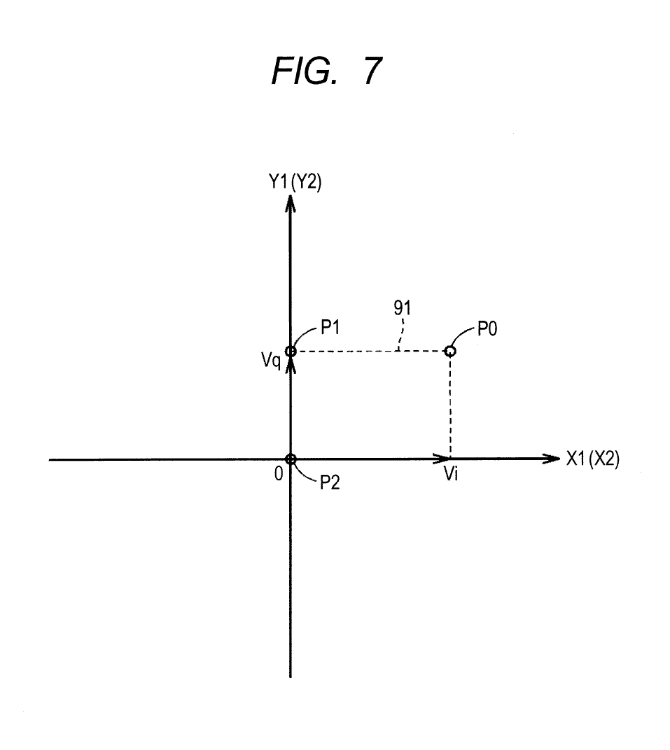

FIG. 7 is a diagram for describing an offset correcting operation where the switches SW1 and SW2 are changed over. Referring to FIGS. 2 and 7, the offset correction values Mi and Mq are both assumed to be 0 in an initial state at the calibration.

Firstly, the controller 12 allows the selector 40 to input the local oscillation signal LO_I to the phase detector 41 and brings the switches SW1 and SW2 to an ON state and an OFF state respectively. In this state, the controller 12 adjusts the offset correction value Mi. Since the second local oscillation signal LO_Q is cut off in this case, the first input signal Vin1 inputted to the phase detector 41 becomes only a carrier leak based on a DC offset Vi between the differential input terminals IT and IB, which is represented as Vin1=Vi×sin(wt+q1) . . . (11). Since the second input signal Vin2 inputted to the phase detector 41 is represented by the above equation (5), the output voltage VPDi of the phase detector 41 becomes VPDi=B×C/2×Vi×cos(q1−q2)=B×C/2×Vi×cos θ . . . (12).

When the offset correction value Mi is changed, a point indicative of each DC offset voltage moves along a straight line 91 from a point P0 on a coordinate plane of FIG. 7. As is apparent from the equation (12), the DC offset voltage V1 coincides with the output voltage VPDi of the phase detector 41 in its positive/negative form. Therefore, the DC offset voltage V1 on the I signal side becomes 0 at a point P1 where the output voltage of the phase detector 41 is changed from positive to negative.

Next, the controller 12 allows the selector 40 to input the local oscillation signal LO_Q to the phase detector 41 by the selector 40 and brings the switches SW1 and SW2 to an OFF state and an ON state respectively. In this state, the controller 12 adjusts the offset correction value Mq. Since the first local oscillation signal LO_I is cut off in this case, the first input signal Vin1 inputted to the phase detector 41 becomes only a carrier leak based on a DC offset Vq between the differential input terminals QT and QB, which is represented as Vin1=Vq×sin(wt+q1+90°) . . . (13). Since the second input signal Vin2 inputted to the phase detector 41 is represented by the above equation (6), the output voltage VPDq of the phase detector 41 becomes VPDq=B×C/2×Vq×cos(q1−q2)=B×C/2×Vq×cos θ . . . (14).

When the offset correction value Mq is changed, the point indicative of each DC offset voltage moves along a coordinate axis Y1 from the point P1 on the coordinate plane of FIG. 7. As is apparent from the equation (14), the DC offset voltage Vq coincides with the output voltage VPDq of the phase detector 41 in its positive/negative form. Therefore, the DC offset voltage Vq on the Q signal side becomes 0 at a point P2 where the output voltage of the phase detector 41 is changed from positive to negative.

Thus, when the switching between the switches SW1 and SW2 is performed, one adjustment in DC offset on the I signal side and one adjustment in DC offset on the Q signal side make it possible to adjust the carrier leaks to approximately 0 regardless of whether the phase difference θ=q1−q2 is 0.

In a special case in which the phase difference θ=q1−q2 becomes 90° or −90°, cos θ=0 in the equations (12) and (14). Therefore, the output voltages VPDi and VPDq of the phase detector 41 reach 0 regardless of the magnitudes of the DC offset voltages, so that the DC offset voltages cannot be adjusted.

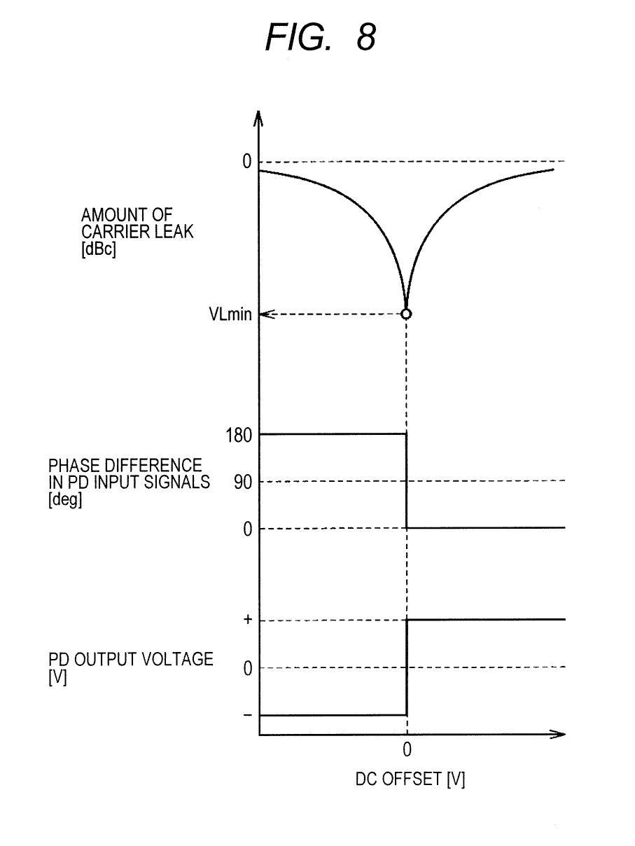

FIG. 8 is a diagram showing a relationship between the amount of carrier leak and each output voltage of the phase detector 41 (PD) in the case of FIG. 7. Referring to FIG. 8, when the DC offset voltage between the differential input terminals of the orthogonal modulation unit 30 is 0, the amount of carrier leak becomes a minimum value VLmin. When the switches SW1 and SW2 are changed over, the offset voltage and the output voltage of the phase detector coincide with each other in positive/negative form. It is therefore possible to adjust the amount of carrier leak to the minimum value VLmin. When the output voltage of the phase detector 41 is changed from negative to positive or vice verse, the difference in phase between the input signals of the phase detector 41 is changed 180°.

### [Procedure for DC Offset Correction]

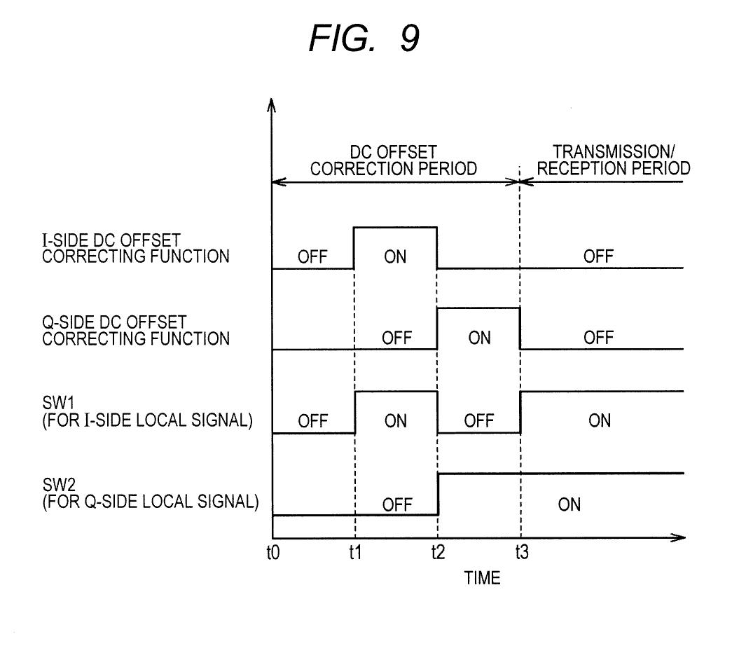

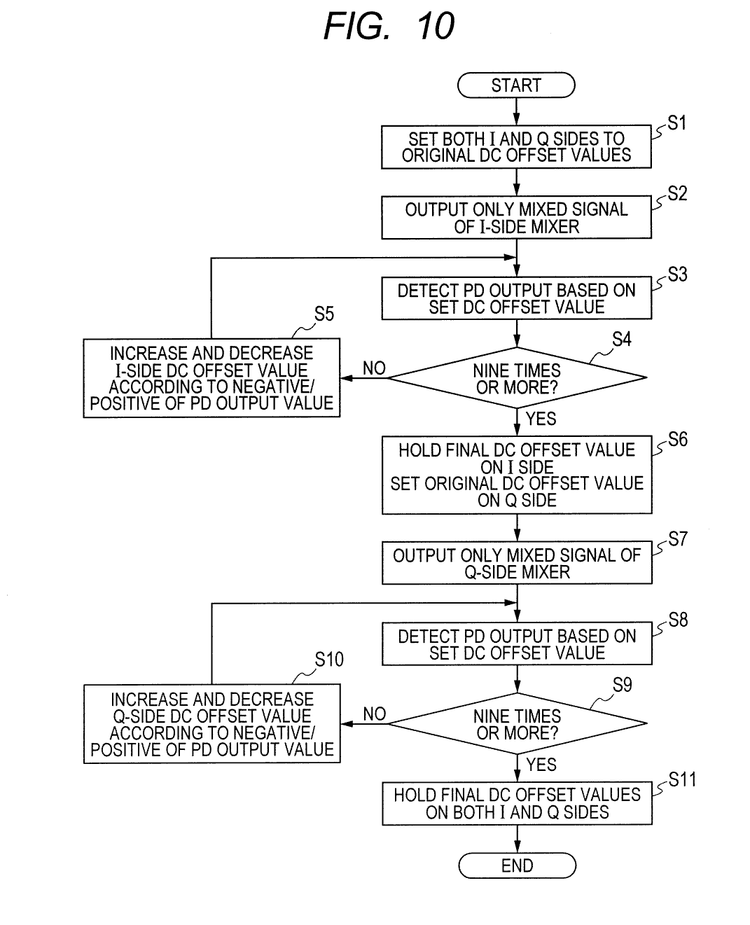

A procedure for the DC offset correction of the orthogonal modulation unit 30 will be summarized below with reference to the timing diagram of FIG. 9 and the flowchart of FIG. 10.

FIG. 9 is a timing diagram showing a procedure for DC offset correction by the controller 12 shown in FIG. 2. In FIG. 9, a time t0 to t3 indicate a DC offset correction period (calibration mode), and the time after the time t3 indicates a transmission/reception period (transmission/reception mode). During the DC offset correction period, the DC offset correction on the I signal side is performed at the time t1 to t2, and the DC offset correction on the Q signal side is performed at the time t2 to t3 successively.

During the period between the times t1 and t2 at which the DC offset correction on the I signal side is performed, the controller 12 brings the switch SW1 for the local oscillation signal (local signal) on the I signal side to an ON state and brings the switch SW2 for the local oscillation signal (local signal) on the Q signal side to an OFF state. During the period between the times t2 and t3 at which the DC offset correction on the Q signal side is performed, the controller 12 brings the switch SW1 for the local oscillation signal (local signal) on the I signal side to an OFF state and brings the switch SW2 for the local oscillation signal (local signal) on the Q signal side to an ON state. During the transmission/reception period (after the time t3), the controller 12 brings both the switches SW1 and SW2 to the ON state.

FIG. 10 is a flowchart showing the procedure for DC offset correction by the controller 12 shown in FIG. 2. Referring to FIGS. 2 and 10, at Step S1, the controller 12 sets the DC offset correction values Mi and Mq of FIG. 2 to an initial value (0) on both the I and Q signal sides.

At the next Step S2, the controller 12 brings the switch SW1 to the ON state and brings the switch SW2 to the OFF state, thereby outputting the local oscillation signal LO_I to the mixer 34 on the I signal side and avoiding the output of the local oscillation signal LO_Q to the mixer 35 on the Q signal side. Namely, the controller 12 causes only the mixer 34 on the I signal side to output a mixed signal.

At the next Step S3, the controller 12 allows the selector 40 to select the local oscillation signal LO_I on the I signal side and detects the outputs of the phase detector 41 at the set DC offset correction values Mi and Mq. The DC offset correction value Mq on the Q signal side is of an initial value (0) and constant. After the DC offset correction value Mi on the I signal side has been set to the initial value (0), the DC offset correction value Mi is set to a value increased or decreased at Step S5 to be described later.

At the next Step S4, the controller 12 determines whether the number of times the DC offset correction value Mi increases or decreases reaches a predetermined number of times (nine times in the case of FIG. 10). When it is found not to have reached the predetermined number of times (when the answer is found to be NO at Step S4), the controller 12 proceeds the process to Step S5.

At Step S5, the controller 12 increases or decreases the DC offset correction value Mi on the I signal side according to the positive and negative of the output voltage of the phase detector 41. The controller 12 increases the DC offset correction value Mi on the I signal side where the output voltage of the phase detector 41 is negative, and decreases the DC offset correction value Mi on the I signal side where the output voltage of the phase detector 41 is positive. At this time, the controller 12 reduces by half the amount of increase/decrease in the DC offset correction value for each number of times as in, for example, a case where the first amount of increase/decrease therein is “10000000” (the seventh power of 2) in binary notation and the second amount of increase/decrease therein is “1000000” (the sixth power of 2) in binary notation. Accordingly, the eighth amount of increase/decrease therein becomes “1” in binary notation and can hence be adjusted to the minimum bit. After the DC offset correction value Mi on the I signal side has been set to the post-increase/decrease value, Step S3 is executed again.

When the number of times the DC offset correction value Mi increases or decreases reaches a predetermined number of times (when the answer is YES at Step S4) at Step S4, the controller 12 proceeds the process to Step S6. At Step S6, the controller 12 holds the final DC offset correction value Mi on the I signal side at the time that it has increased or decreased at Step S5. The DC offset correction value Mq on the Q signal side has been set to the initial value (0).

Next, at Step S7, the controller 12 brings the switch SW1 to an OFF state and brings the switch SW2 to an ON state to thereby output the local oscillation signal LO_Q to the mixer 35 on the Q signal side and avoid the output of the local oscillation signal LO_I to the mixer 34 on the I signal side. Namely, the controller 12 causes only the mixer 35 on the Q signal side to output a mixed signal.

At the next Step S8, the controller 12 allows the selector 40 to select the local oscillation signal LO_Q on the Q signal side and thereby detects the outputs of the phase detector 41 at the set DC offset correction values Mi and Mq. The DC offset correction value Mi on the I signal side is set to the final offset correction value held at Step S6 and remains unchanged. The initial value of the DC offset correction value Mq on the Q signal side is 0 and its subsequent value is set to a value increased or decreased at Step S10 to be described later.

At the next Step S9, the controller 12 determines whether the number of times the DC offset correction value Mq on the Q signal side increases or decrease reaches the predetermined number of times (nine times in the case of FIG. 10). When it is found not to have reached the predetermined number of times (when the answer is found to be NO at Step S9), the controller 12 proceeds the process to Step S10.

At Step S10, the controller 12 increases or decreases the DC offset correction value Mq on the Q signal side according to the positive and negative of the output voltage of the phase detector 41. The controller 12 increases the DC offset correction value Mq on the Q signal side where the output voltage of the phase detector 41 is negative, and decreases the DC offset correction value Mq on the Q signal side where the output of the phase detector 41 is positive. At this time, the controller 12 reduces by half the amount of increase/decrease in the DC offset correction value for each number of times in a manner similar to the case at Step S5, thereby making it possible to adjust it to the minimum bit. After the DC offset correction value Mq on the Q signal side has been set to the post-increase/decrease value, Step S8 is carried out again.

When the number of times the DC offset correction value Mq on the Q signal side increases or decreases reaches the predetermined number of times at Step S9 (when the answer is YES at Step S9), the controller 12 proceeds the process to Step S21.

At Step S21, the controller 12 holds the final DC offset correction value Mq on the Q signal side at the time that it has increased or decreased at Step S10. At this time, the final DC offset correction value at the time that it has increased or decreased at Step S5, is held on the I signal side. The procedure for the offset correction by the controller 12 is ended in the above-described manner.

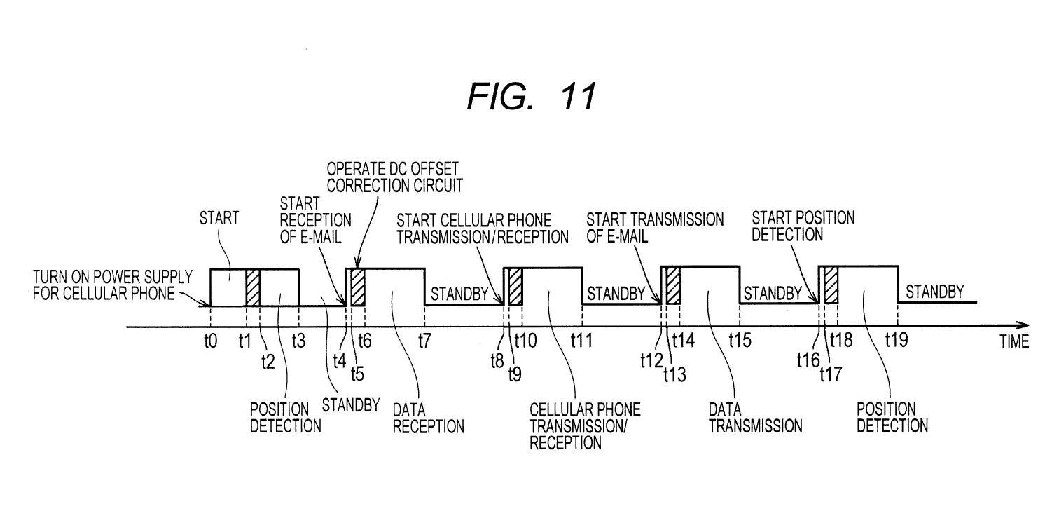

FIG. 11 is a diagram for describing timings for DC offset correction where the RFIC 10 of FIG. 2 is applied to a cellular phone.

Referring to FIG. 11, when a power supply for the cellular phone is turned ON at a time t0, the operation of start of the cellular phone is performed. At a time t1 to t2 after the time t0, a DC offset correction is carried out. Subsequently, the transmission/reception of a control signal between the cellular phone and its corresponding base station is performed to detect the position of the cellular phone at a time t2 to t3.

When the operation of reception of e-mail is started at the next time t4 after a standby time, a DC offset correction is performed at a time t5 to t6 subsequent to the time t4. The actual reception of data is carried out between the subsequent times t6 and t7. Since the control signal is transmitted from the cellular phone even at data reception, it is necessary to correct a DC offset prior to the transmission of the control signal.

When the operation of transmission/reception of the cellular phone is started at the next time t8 after a standby time, a DC offset correction is executed between times t9 and t10 subsequent to the time t8. An actual call is performed between the subsequent times t10 and t11.

When the operation of transmission of e-mail is started at the next time t12 after a standby time, a DC offset correction is executed between the subsequent times t13 and t14. Actual data transmission is performed between the subsequent times t14 and t15.

When the operation of detecting the position of the cellular phone is started at the time t16 with the movement of a cellular phone's user, a DC offset correction is executed between the subsequent times t17 and t18. The transmission/reception of a control signal between the cellular phone and its corresponding base station is performed to detect the position of the cellular phone between the subsequent times t18 and t19.

Thus, since it is necessary to perform the offset correcting operation every time before the transmission/reception of the signal in the case of the cellular phone, there is a large merit in that a high-accuracy offset correction is performed by the offset correcting function of the RFIC 10 of the first embodiment.

### [Detailed Configurations of Respective Parts in FIG. 2]

Suitable circuit configurations of the respective parts in FIG. 2 will be explained below.

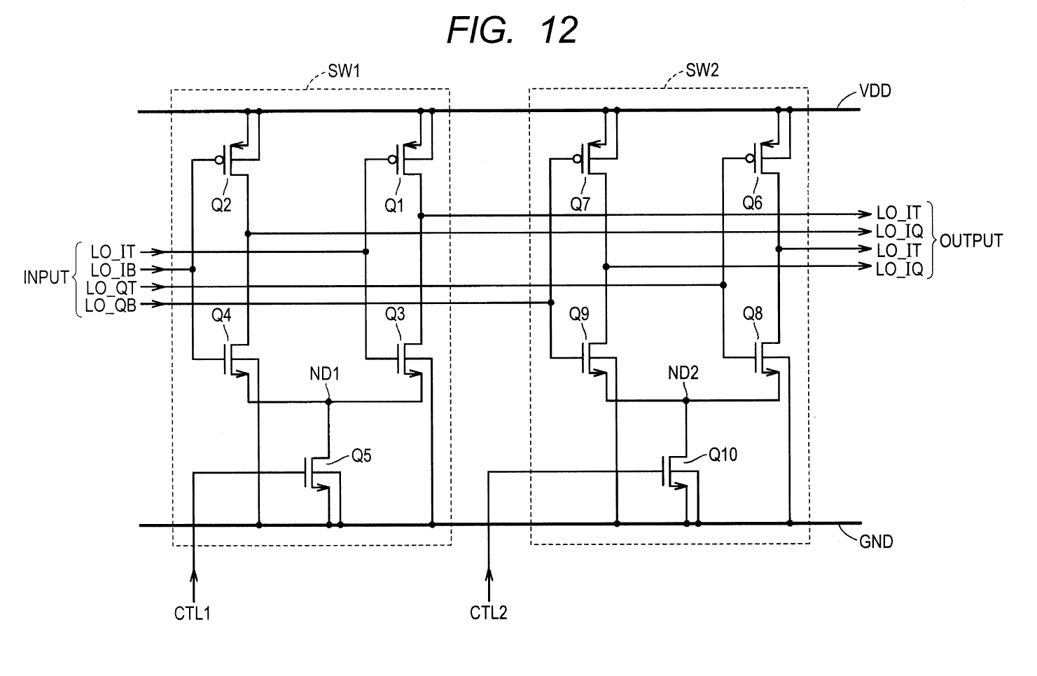

FIG. 12 is a circuit diagram showing one example illustrative of configurations of the switches SW1 and SW2 shown in FIG. 2. Referring to FIG. 12, the switch SW1 includes PMOS (P-channel Metal Oxide Semiconductor) transistors Q1 and Q2 and NMOS (N-channel Metal Oxide Semiconductor) transistors Q3 through Q5. The PMOS transistors Q1 and the NMOS transistor Q3 configure an inverter and are coupled between a power supply line VDD and a node ND1 in this order. A local oscillation signal LO_IT is inputted to gates of the transistors Q1 and Q3. Similarly, the PMOS transistor Q2 and the NMOS transistor Q4 configure an inverter and are coupled between the power supply line VDD and the node ND1 in this order. A local oscillation signal LO_IB is inputted to gates of the transistors Q2 and Q4.

The NMOS transistor Q5 is coupled between the node ND1 and a ground line GND. The control signal CTL1 outputted from the controller 12 shown in FIG. 2 is inputted to a gate of the transistor Q5. Since the transistor Q5 is made conductive when the control signal CTL1 is of a high (H) level, the inverter configured by the transistors Q1 and Q3 and the inverter configured by the transistors Q2 and Q4 are operated. As a result, the local oscillation signal LO_IT is outputted from a connecting node of the transistors Q1 and Q3, and the local oscillation signal LO_IB is outputted from a connecting node of the transistors Q2 and Q4. Since the transistor Q5 is placed in an OFF state when the control signal CTL1 is of a low (L) level, neither the inverter configured by the transistors Q1 and Q3 nor the inverter configured by the transistors Q2 and Q4 is operated. As a result, the local oscillation signals LO_IT and LO_IB are cut off. Since, at this time, the transistors Q1 and Q2 and the transistors Q6 and Q7 are repeatedly turned on and off in sync with the periods of the local oscillation signals LO_IT, LO_IB, LO_QT and LO_QB respectively, the outputs of the respective inverters are fixed to an approximately constant voltage (power supply voltage). Incidentally, although unillustrated in FIG. 12, a buffer inverter is further provided on the output side of the switch SW1.

Since the switch SW2 is similar in configuration and operation to the switch SW1, their explanations will not be repeated. In the description of the switch SW1, the transistors Q1 through Q5 correspond to the transistors Q6 through Q10, the node ND1 corresponds to a node N2, and the local oscillation signals LO_IT and LO_IB correspond to the local oscillation signals LO_QT and LO_QB, respectively.

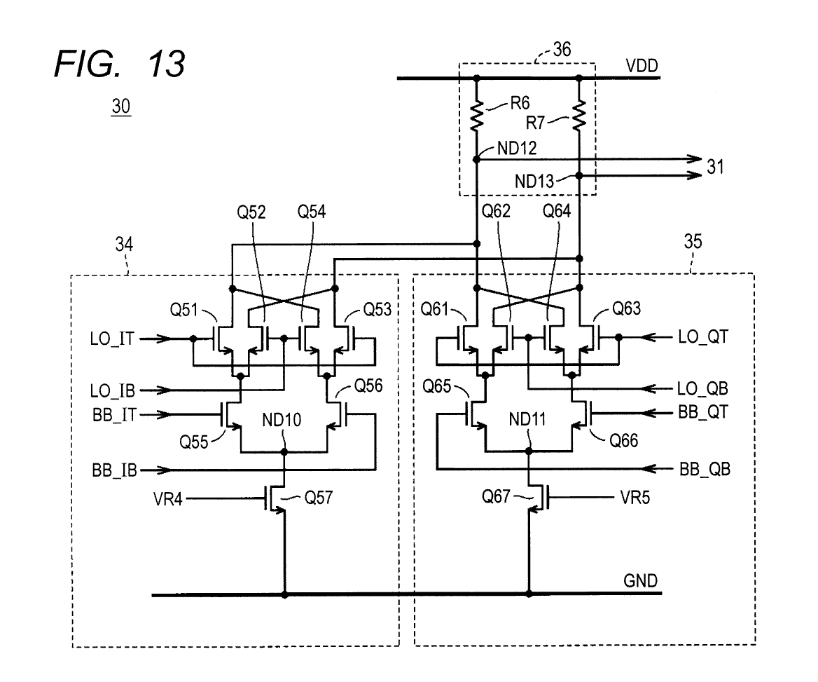

FIG. 13 is a circuit diagram showing one example of a configuration of a portion excepting the switches SW1 and SW2 of the orthogonal modulation unit 30 shown in FIG. 2.

Referring to FIG. 13, the mixer 34 includes NMOS transistors Q51 through Q57. The mixer 35 includes NMOS transistors Q61 through Q67. The adder 36 includes resistive elements R6 and R7.

The mixer 34 is of a Gilbert cell mixer. Couplings of the respective elements of the mixer 34 will be explained below. Sources of the transistors Q51 and Q52 are both coupled to a node ND10 via the transistor Q55, and sources of the transistors Q53 and Q54 are both coupled to the node ND10 via the transistor Q56. The transistor Q57 for a current source is coupled between the node ND10 and a ground line GND. Drains of the transistors Q51 and Q54 are both coupled to a node ND12, and drains of the transistors Q52 and Q53 are both coupled to a node ND13. The nodes ND12 and ND13 are respectively coupled to the power supply line VDD via the resistive elements R6 and R7. The local oscillation signal LO_IT is commonly inputted to gates of the transistors Q51 and Q53, and the local oscillation signal LO_IB is commonly inputted to gates of the transistors Q52 and Q54. The I signals BB_IT and BB_IB are respectively inputted to gates of the transistors Q55 and Q56. A predetermined bias voltage VR4 is applied to a gate of the transistor Q57. A signal obtained by mixing the local oscillation signal LO_I and the I signal BB_I with each other is outputted between the nodes ND12 and ND13 by the above circuit configuration.

Since the mixer 35 is also of a Gilbert cell mixer of the same configuration as that of the mixer 34, its explanation will not be repeated. In the description of the mixer 34, the transistors Q51 through Q57 correspond to the transistors Q61 through Q67, the node ND10 corresponds to a node ND11, and the bias voltage VR4 corresponds to a bias voltage VR5, respectively.

The resistive elements R6 and R7 that configure the adder 36 are used as load resistors common to the mixers 34 and 35. Thus, when the switches SW1 and SW2 of FIG. 2 are both in an ON state, an ac signal component outputted from between the nodes ND12 and ND13 becomes a signal obtained by adding an ac signal outputted from the mixer 34 and an ac signal outputted from the mixer 35. When only the switch SW1 is in the ON state in a calibration mode, the ac signal component outputted from between the nodes ND12 and ND13 becomes the ac signal outputted from the mixer 34. When only the switch SW2 is in the ON state, the ac signal component outputted from between the nodes ND12 and ND13 becomes the ac signal outputted from the mixer 35.

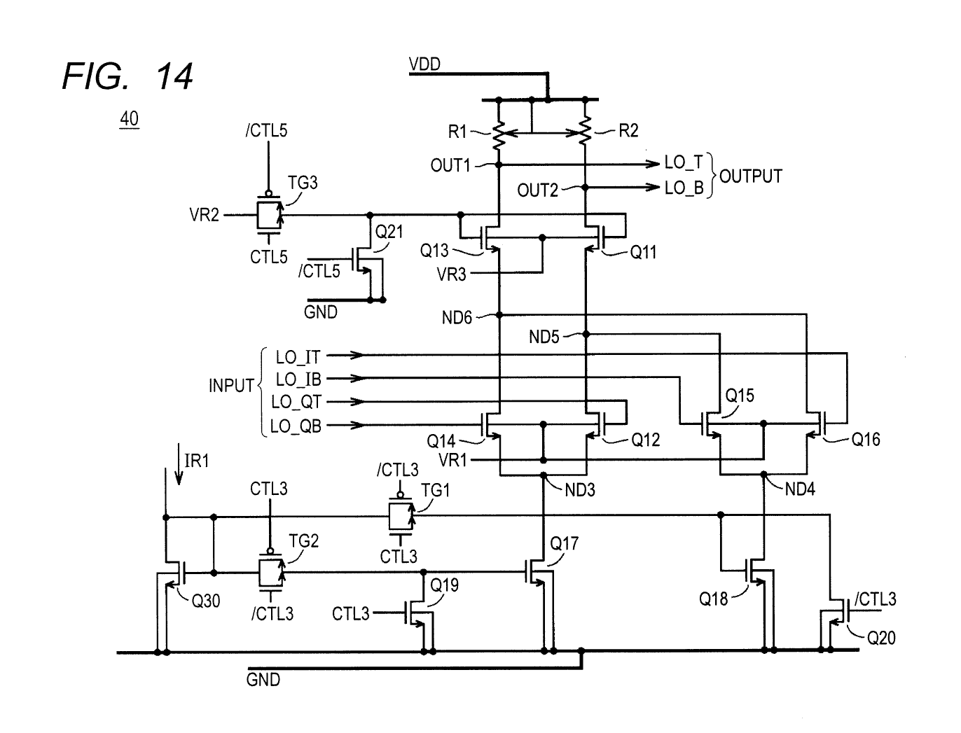

FIG. 14 is a circuit diagram illustrating one example of a configuration of the selector 40 shown in FIG. 2. Referring to FIG. 14, the selector 40 includes NMOS transistors Q11 through Q21 and Q30, transmission gates TG1 through TG3, and resistive elements R1 and R2. Couplings between these components will first be explained.

The resistive element R2 and the transistors Q11 and Q12 are coupled in series between the power supply line VDD and a node ND3 in this order. The resistive element R1 and the transistors Q13 and Q14 are coupled in series between the power supply line VDD and the node ND3 in this order. The transistor Q17 is coupled between the node ND3 and the ground line GND and used as a current source. The above resistive elements R1 and R2 and transistors Q11 through Q14 and Q17 configure a cascode amplifier circuit. The local oscillation signals LO_QT and LO_QB are respectively inputted to gates of the differential pair of transistors Q12 and Q14. Drains of the transistors Q13 and Q11 are used as output nodes OUT1 and OUT2.

The transistor Q15 is coupled between a coupling node ND5 of the transistors Q11 and Q12 and a node ND4, and the transistor Q16 is coupled between a coupling node ND6 of the transistors Q13 and Q14 and the node ND4. The transistor Q18 is coupled between the node ND4 and the ground line GND and used as a current source. The local oscillation signals LO_IT and LO_IB are respectively inputted to gates of the differential pair of transistors Q16 and Q15. The differential pair of transistors Q16 and Q15 shares the resistive elements R1 and R2 used as load resistors and the transistors Q11 and Q13 with the differential pair of transistors Q12 and Q14. A predetermined bias voltage VR1 is supplied to back gates of the differential pair of transistors Q16 and Q15 and the differential pair of transistors Q12 and Q14.

A drain and gate of the diode-coupled transistor Q30 are coupled to a gate of the transistor Q18 through the transmission gate TG1 and coupled to a gate of the transistor Q17 through the transmission gate TG2. Further, the gates of the transistors Q17 and Q18 are respectively grounded through the transistors Q19 and Q20. Back gates of the transistors Q17 through Q20 are grounded.

When the control signal CTL3 outputted from the controller 12 is of an H level in the above circuit configuration, the transmission gate TG1 is brought to an ON state, the transmission gate TG2 is brought to an OFF state, the transistor Q20 is brought to an OFF state, and the transistor Q19 is brought to an ON state. Thus, a reference current IR1 supplied to the drain of the transistor Q30 flows through the transistor Q18. On the other hand, the transistor Q17 is brought to an OFF state. As a result, the local oscillation signals LO_IT and LO_IB respectively supplied to the gates of the differential pair of transistors Q16 and Q15 are outputted from the output nodes OUT1 and OUT2 respectively.

When the control signal CTL3 is of an L level, the ON and OFF states become opposite to the above, so that the local oscillation signals LO_QT and LO_QB respectively supplied to the gates of the differential pair of transistors Q12 and Q14 are outputted from the output nodes OUT1 and OUT2 respectively.

Incidentally, gates of the transistors Q11 and Q13 are supplied with a predetermined bias voltage VR2 through the transmission gate TG3 to stop the operation of selection by the selector 40 and grounded via the transistor Q21. Further, a predetermined bias voltage VR3 is supplied to back gates of the transistors Q11 and Q13. Thus, when a control signal CTL5 is of an H level, the transmission gate TG3 is brought to an ON state and the transistor Q21 is brought to an OFF state, so that the selector 40 performs a selection operation. When the control signal CTL5 is of an L level, the transistors Q11 and Q13 are brought to an OFF state, so that the output nodes OUT1 and OUT2 are fixed to an H level and the selector 40 stops the selection operation.

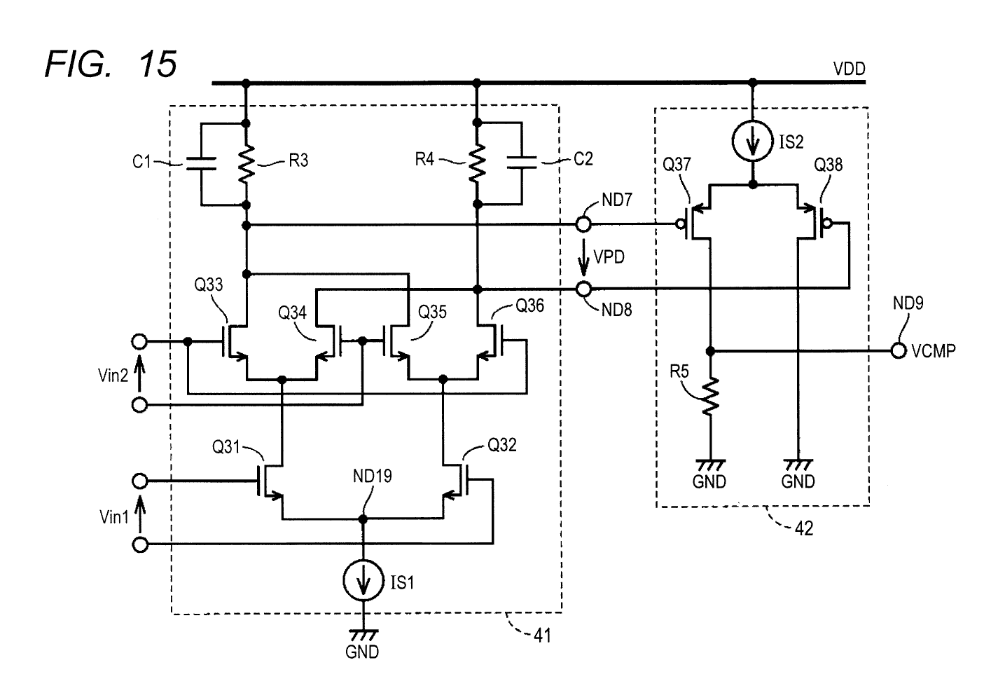

FIG. 15 is a circuit diagram showing one example of a configuration of the phase detector 41 and comparator 42 shown in FIG. 2.

Referring to FIG. 15, the phase detector 41 is of a circuit in which capacitors for the low-pass filter are added to a Gilbert cell multiplexer. The phase detector 41 includes NMOS transistors Q31 through Q36, resistive elements R3 and R4, capacitors C1 and C2, and a current source IS1. Couplings between these components will first be explained.

Sources of the transistors Q33 and Q34 are both coupled to a node ND19 through the transistor Q31, and sources of the transistors Q35 and Q36 are both coupled to the node ND19 through the transistor Q32. The current source IS1 is provided between the node ND19 and a ground node GND. Drains of the transistors Q33 and Q35 are both coupled to an output node ND7, and drains of the transistors Q34 and Q36 are both coupled to an output node ND8. Gates of the transistors Q33 and Q36 are coupled to each other, and gates of the transistors Q34 and Q35 are intercoupled with each other. The resistive element R3 is coupled between the power supply line VDD and the output node ND7, and the capacitor C1 is coupled in parallel with the resistive element R3. The resistive element R4 is coupled between the power supply line VDD and the output node ND8, and the capacitor C2 is coupled in parallel with the resistive element R4.

In the above circuit configuration, a first differential input signal Vin1 is inputted between a gate of the transistor Q31 and a gate of the transistor Q32. A second differential input signal Vin2 is inputted between gates of the transistors Q33 and Q36 and gates of the transistors Q34 and Q35. As a result, the product of the first differential input signal Vin1 and the second differential input signal Vin2 is outputted from between the output nodes ND7 and ND8 as an output voltage VPD. Since the output nodes ND7 and ND8 are respectively coupled to the power supply line VDD through the capacitors C1 and C2 at this time, an ac component of the output voltage VPD is eliminated.

Next, the comparator 42 includes PMOS transistors Q37 and Q38, a resistive element R5 and a current source IS2. Couplings between these components will first be explained.

Sources of the transistors Q37 and Q38 are both coupled to the power supply line VDD through the current source IS2. Gates of the transistors Q37 and Q38 are respectively coupled to the output nodes ND7 and ND8 of the phase detector 41. A drain of the transistor Q37 is grounded via the resistive element R5, and a drain of the transistor Q38 is grounded. A drain of the transistor Q37 is further coupled to an output node ND9.

When the voltage of the output node ND8 of the phase detector 41 is higher than the voltage of the output node ND7 in the above circuit configuration (the output voltage VPD is positive), the current outputted from the current source IS2 principally flows through the transistor Q37 so that an output voltage VCMP developed across the resistive element R5 becomes an H level. When the output voltage VPD is negative in reverse, the current outputted from the current source IS2 principally flows through the transistor Q38 so that the output voltage VCMP developed across the resistive element R5 becomes an L level.

### SUMMARY

According to the RFIC 10 of the first embodiment as described above, the switches SW1 and SW2 are respectively provided in the transmission paths for the local oscillation signals LO_I and LO_Q, lying between the local signal generation unit 39 and the mixers 34 and 35.

When the DC offset on the I signal side is adjusted during calibration, the controller 12 brings the switch SW1 to the ON state and brings the switch SW2 to the OFF state. Thus, only the carrier leak signal on the I signal side is outputted from the orthogonal modulation unit 30. As a result, the DC offset on the I signal side can be adjusted with a degree of accuracy higher than conventional. On the other hand, when the DC offset on the Q signal side is adjusted, the controller 12 brings the switch SW1 to the OFF state and brings the switch SW2 to the ON state. Thus, only the carrier leak signal on the Q signal side is outputted from the orthogonal modulation unit 30. As a result, the DC offset on the Q signal side can be adjusted with a degree of accuracy higher than conventional.

In the above description, the I signal Di and the offset correction value Mi are added by the digital adder 32 as shown in FIG. 2, and the Q signal Dq and the offset correction value Mq are added by the digital adder 33. Instead of the digital adders 32 and 33, analog adders may respectively be provided between the amplifiers 26 and 27 and the mixers 34 and 35. In this case, a DC offset correction signal obtained by converting the offset correction value Mi into analog form is added to its corresponding I signal BB_I, and a DC offset correction signal obtained by converting the offset correction value Mq into analog form is added to its corresponding digital Q signal BB_Q.

Although the above description has been made of the case in which the phase detector 41 is of such an analog type that it is configured by the multiplier and the low-pass filter, the phase detector 41 is not limited to this configuration. For example, a digital phase detector can also be used which is called a phase frequency comparator.

### Modification of First Embodiment

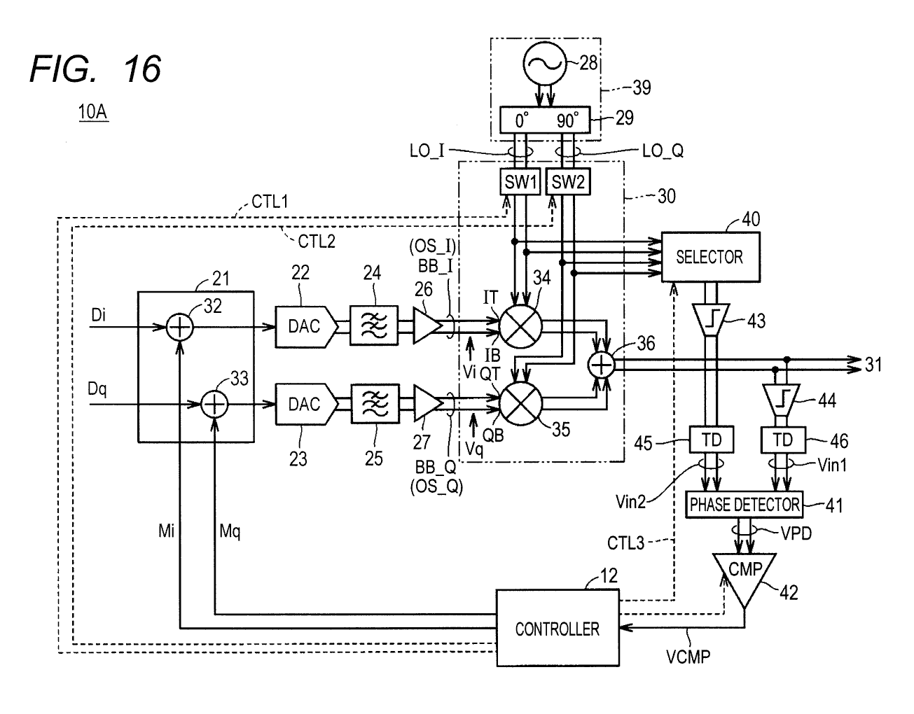

FIG. 16 is a block diagram showing a portion related to a DC offset correction, of an RFIC 10A according to a modification of the first embodiment of the present invention. The RFIC 10A shown in FIG. 16 differs from the RFIC 10 shown in FIG. 2 in that it includes limiting amplifiers 43 and 44 and time delays 45 and 46 (TD). Since the RFIC 10A shown in FIG. 6 is identical to the RFIC 10 of FIG. 2 in other respects, the same or corresponding parts are respectively identified by the same reference numerals, and their explanations will not therefore be repeated.

As shown in FIG. 16, the limiting amplifier 44 and the delay circuit 46 are provided between the adder 36 and the phase detector 41 in this order. During calibration, a carrier leak signal outputted from the orthogonal modulation unit 30 is amplified to a power supply voltage level by the limiting amplifier 44, which in turn is phase-adjusted by the time delay 46. Similarly, the limiting amplifier 43 and the time delay 45 are provided between the selector 40 and the phase detector 41 in this order. A local oscillation signal LO_I or LO_Q outputted from the selector 40 is amplified to the power supply voltage level by the liming amplifier 43, which in turn is phase-adjusted by the time delay 45.

Converting sine waves into square waves by the limiting amplifiers 43 and 44 respectively enables an improvement in the accuracy of detection of the phase difference by the phase detector 41. The time delays 45 and 46 are provided to set the difference in phase between the input signals Vin2 and Vin1 of the phase detector 41 to a predetermined suitable range. When the phase detector 41 is configured by the multiplier and the low-pass filter, the difference in phase between the input signals Vin2 and Vin1 may desirably be a value near zero. Since cos θ=1 in the above equations (12) and (14) in this case, it is possible to avoid θ=90° or −90°.

### Second Embodiment

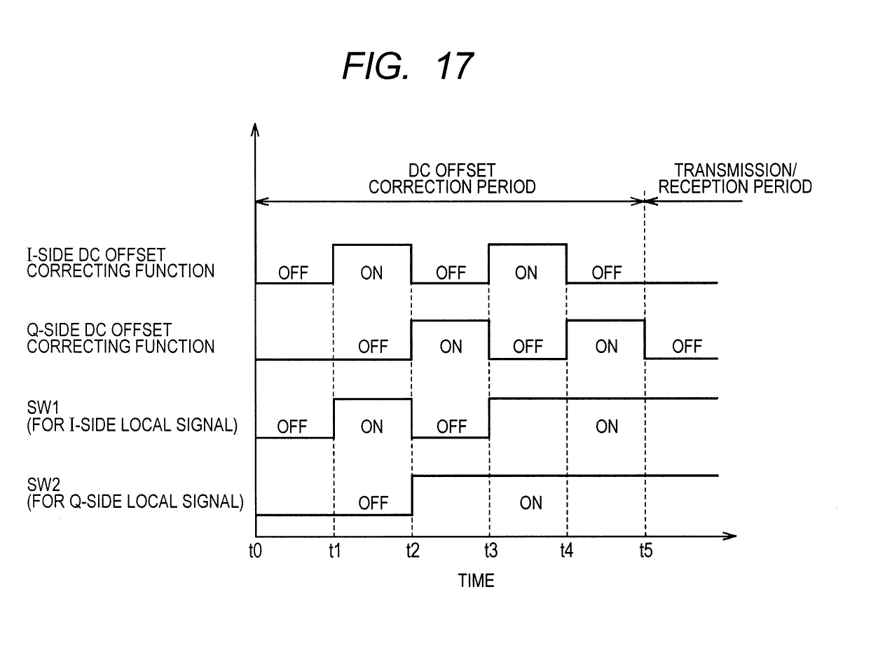

FIG. 17 is a timing diagram showing a procedure for DC offset correction according to a second embodiment of the present invention. The timing diagram shown in FIG. 17 is different from the timing diagram of the first embodiment shown in FIG. 9 in that a DC offset correction on the I signal side from the time t3 to t4, and a DC offset correction on the Q signal side from the time t4 to t5 are further added. Since the second embodiment is identical to the first embodiment of FIG. 9 in DC offset correction between the times t1 and t3, its description will not therefore be repeated.

Referring to FIGS. 2 and 17, the controller 12 brings both the switches SW1 and SW2 to an ON state during a period from the time t3 and t4 at which the DC offset correction on the I signal side is performed. In this condition, a difference in phase between the output signal of the orthogonal modulation unit 30 and the local oscillation signal LO_I on the I signal side selected by the selector 40 is detected by the phase detector 41. Similarly, the controller 12 brings both the switches SW1 and SW2 to the ON state during a period from the time t4 and t5 at which the DC offset correction on the Q signal side is performed. In this condition, a difference in phase between the output signal of the orthogonal modulation unit 30 and the local oscillation signal LO_Q on the Q signal side, which is selected by the selector 40, is detected by the phase detector 41.

During a period from the time t1 to t2, the controller 12 brings the switch SW1 to the ON state and brings the switch SW2 to an OFF state in such a manner that only a carrier leak on the I signal side is outputted, thereby to perform an offset correction on the I signal side in such a manner that the carrier leak becomes a minimum. Similarly, during a period from the time t2 to t3, the controller 12 brings the switch SW1 to an OFF state and brings the switch SW2 to the ON state in such a manner that only a carrier leak on the Q signal side is outputted, thereby to perform an offset correction on the Q signal side in such a manner that the carrier leak becomes a minimum. It is thus not possible to perform, during these periods, an offset adjustment where the carrier leak on the I signal side and the carrier leak on the Q signal side interfere with each other. Therefore, at the time t3 to t5, the controller 12 brings both the switches SW1 and SW2 to the ON state to output a combined signal of the carrier leak on the I signal side and the carrier leak on the Q signal side from the orthogonal modulation unit 30, thereby performing an offset correction. Consequently, the accuracy of a DC offset correction where the carrier leak on the I signal side and the carrier leak on the Q signal side interfere with each other can be made higher than in the case of the first embodiment 1.

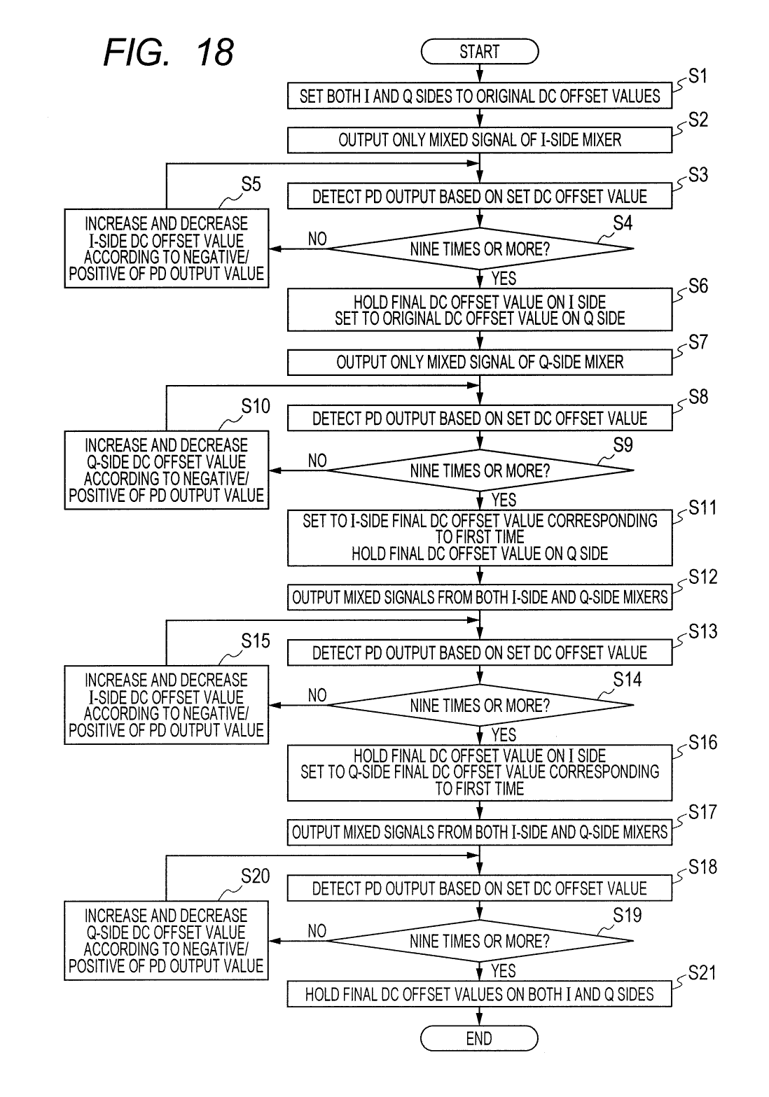

FIG. 18 is a flowchart showing the procedure for the DC offset correction according to the second embodiment of the present invention. In the flowchart shown in FIG. 18, Steps S1 through S10 are the same as those employed in the first embodiment, which are shown in FIG. 10, and their explanations will not therefore be repeated.

Referring to FIGS. 2 and 18, at Step S11, the controller 12 holds therein the final DC offset correction value Mq on the Q signal side, which has increased or decreased at Step S10. The DC offset correction value Mi on the I signal side is set to the offset correction value held at Step S6.

At the next Step S12, the controller 12 brings both the switches SW1 and SW2 to an ON state to thereby output the local oscillation signal LO_I to the mixer 34 on the I signal side and output the local oscillation signal LO_Q to the mixer 35 on the Q signal side. Namely, the controller 12 causes both of the mixers 34 and 35 on the I and Q signal sides to output mixed signals.

At the next Step S13, the controller 12 allows the selector 40 to select the local oscillation signal LO_I on the I signal side and thereby detects the outputs of the phase detector 41 at the set DC offset correction values Mi and Mq. The DC offset correction value Mq on the Q signal side is of the value held at Step S11 and constant. The initial value of the DC offset correction value Mi on the I signal side is of the value set at Step S11, and its subsequent value is set to a value that has increased or decreased at Step S15 to be described later. At the next Step S14, the controller 12 determines whether the number of times the DC offset correction value Mi increases or decreases reaches a predetermined number of times (nine times in the case of FIG. 18). When it is found not to have reached the predetermined number of times (when the answer is found to be NO at Step S14), the controller 12 proceeds the process to Step S15.

At Step S15, the controller 12 increases or decreases the DC offset correction value Mi on the I signal side according to the positive and negative of the output voltage of the phase detector 41. The controller 12 increases the DC offset correction value Mi on the I signal side where the output voltage of the phase detector 41 is negative, and decreases the DC offset correction value Mi on the I signal side where the output voltage of the phase detector 41 is positive. At this time, the controller 12 reduces by half the amount of increase/decrease in the DC offset correction value for each number of times in a manner similar to the cases of Steps S5 and S10 and finally adjusts it to the minimum bit. After the DC offset correction value Mi on the I signal side has been set to the post-increase/decrease value, Step S13 is executed again.

When the number of times the DC offset correction value Mi increases or decreases reaches the predetermined number of times (when the answer is YES at Step S14), the controller 12 proceeds to the process to Step S16. At Step S16, the controller 12 holds the final DC offset correction value Mi on the I signal side at the time that it has increased or decreased at Step S15. The DC offset correction value Mq on the Q signal side is set to the value held at Step S11.

At the next Step S17, the controller 12 brings both the switches SW1 and SW2 to the ON state to thereby output the local oscillation signal LO_I to the mixer 34 on the I signal side and output the local oscillation signal LO_Q to the mixer 35 on the Q signal side. Namely, the controller 12 causes both the mixers 34 and 35 on the I and Q signal sides to output mixed signals.

At the next Step S18, the controller 12 allows the selector 40 to select the local oscillation signal LO_Q on the Q signal side and thereby detects the outputs of the phase detector 41 at the set DC offset correction values Mi and Mq. The DC offset correction value Mi on the I signal side is set to the final offset correction value held at Step S16 and remains unchanged. The initial value of the DC offset correction value Mq on the Q signal side is of the value held at Step S11, and its subsequent value is set to a value increased or decreased at Step S20 to be described later.

At the next Step S19, the controller 12 determines whether the number of times the DC offset correction value Mq on the Q signal side increases or decreases reaches the predetermined number of times (nine times in the case of FIG. 18). When it is found not to have reached the predetermined number of times (when the answer is found to be NO at Step S19), the controller 12 proceeds the process to Step S20.

At Step S20, the controller 12 increases or decreases the DC offset correction value Mq on the Q signal side according to the positive and negative of the output voltage of the phase detector 41. The controller 12 increases the DC offset correction value Mq on the Q signal side where the output voltage of the phase detector 41 is negative, and decreases the DC offset correction value Mq on the Q signal side where the output of the phase detector 41 is positive. At this time, the controller 12 reduces by half the amount of increase/decrease in the DC offset correction value for each number of times in a manner similar to the cases at Steps S5, S10 and S15 and thereby adjusts it to the minimum bit for the last time. After the DC offset correction value Mq on the Q signal side has been set to the post-increase/decrease value, Step S18 is carried out again.

When the number of times the DC offset correction value Mq on the Q signal side increases or decreases reaches the predetermined number of times at Step S19 (when the answer is YES at Step S19), the controller 12 proceeds the process to Step S21.

At Step S21, the controller 12 holds the final DC offset correction value Mq on the Q signal side at the time that it has increased or decreased at Step S20. At this time, the final DC offset correction value at the time that it has increased or decreased at Step S15, is held on the I signal side. The procedure for the offset correction by the controller 12 is ended in the above-described manner.

### Third Embodiment

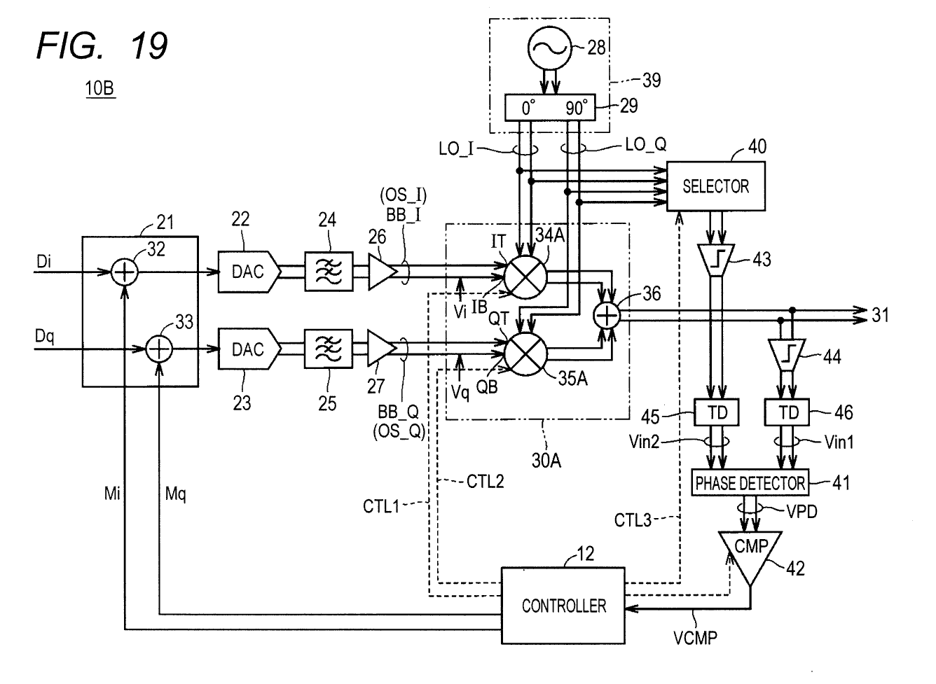

FIG. 19 is a block diagram showing a portion related to a DC offset correction, of an RFIC 10B according to a third embodiment of the present invention.

An orthogonal modulation unit 30A of the RFIC 10B shown in FIG. 19 includes mixers 34A and 35A respectively switched to operating and stopped states according to control signals CTL1 and CTL2 outputted from a controller 12, and an adder 36. That is, the orthogonal modulation unit 30A is different from the orthogonal modulation unit 30 shown in FIG. 16 in that it includes the mixers 34A and 35A respectively switchable to the operating and stopped states instead of the switches SW1 and SW2. Since the RFIC 10B shown in FIG. 19 is identical to the RFIC 10A shown in FIG. 16 in other respects, the same or corresponding parts are respectively identified by like reference numerals, and their explanations will not be repeated.

The mixers 34A and 35A are both controlled to assume the operating state at transmission. In this case, an I signal BB_I and a local oscillation signal LO_I are mixed together by the mixer 34A, and a Q signal BB_Q and a local oscillation signal LO_Q are mixed together by the mixer 35A. The adder 36 adds an ac signal outputted from the mixer 34A and an ac signal outputted from the mixer 35A to generate a transmit signal.

During calibration, the mixer 34A is brought to the operating state and the mixer 35A is brought to the stopped state, so that a signal obtained by mixing an offset correction signal OS_I and the local oscillation signal LO_I by the mixer 34A is outputted from the adder 36. When the mixer 34A is brought to the stopped state and the mixer 35A is brought to the operating state in reverse, a signal obtained by mixing an offset correction signal OS_Q and the local oscillation signal LO_Q by the mixer 35A is outputted from the adder 36. When both of the mixers 34A and 35A are in the operating state, the ac signals outputted from the mixers 34A and 35A are added together by the adder 36, followed by being outputted therefrom.

Accordingly, the orthogonal modulation unit 30A is functionally identical to the orthogonal modulation units 30 employed in the first and second embodiments. It is therefore possible to perform a DC offset correction in accordance with a procedure similar to that employed in each of the first and second embodiments. As a result, a DC offset correction with a degree of accuracy higher than conventional can be carried out in a manner similar to the cases of the first and second embodiments.

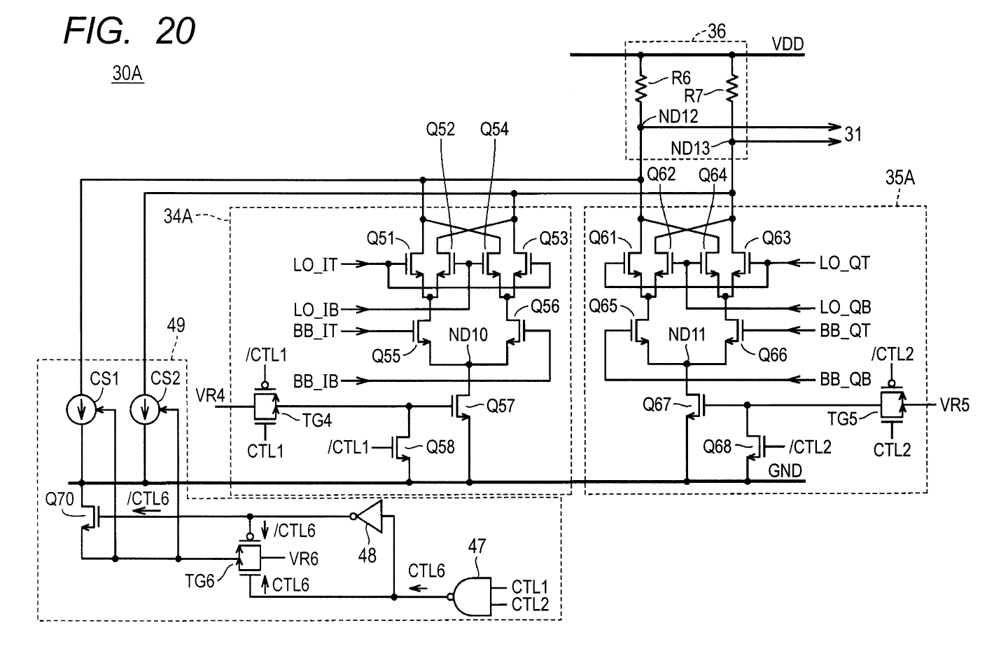

FIG. 20 is a circuit diagram showing one example of a configuration of the orthogonal modulation unit 30A shown in FIG. 19. Referring to FIG. 20, the orthogonal modulation unit 30A includes a current adjustment unit 49 in addition to the mixers 34A and 35A and the adder 36 both shown in FIG. 19. The mixer 34A includes NMOS transistors Q51 through Q58 and a transmission gate TG4. The mixer 35A includes NMOS transistors Q61 through Q68 and a transmission gate TG5. The adder 36 includes resistive elements R6 and R7. The current adjustment unit 49 includes constant current sources CS1 and CS2, a NAND circuit 47, an inverter 48, a transmission gate TG6, and an NMOS transistor Q70.

The mixer 34A is equivalent to one in which the transmission gate TG4 and the NMOS transistor Q58 are added to a Gilbert cell mixer. Similarly, the mixer 35A is equivalent to one in which the transmission gate TG5 and the NMOS transistor Q68 are added to the Gilbert cell mixer. Thus, the configuration from which the transmission gates TG4 and TG5 and the NMOS transistors Q68 and Q69 are eliminated, is the same as the configuration of each of the mixers 34 and 35 shown in FIG. 13. In the following description, parts common to the mixers 34 and 35 shown in FIG. 13 are identified by like reference numerals, and their explanations will not therefore be repeated.

In the mixer 34A shown in FIG. 20, a predetermined bias voltage VR4 is applied to a gate of the transistor Q57 for a current source through the transmission gate TG4, and the gate thereof is grounded via the transistor Q58. A control signal CTL1 is inputted to a gate electrode of the NMOS transistor that configures the transmission gate TG4. A signal /CTL1 obtained by inverting the control signal CTL1 is inputted to a gate electrode of a PMOS transistor of the transmission gate TG4. The signal /CTL1 is inputted to a gate of the NMOS transistor Q58.

Thus, when the control signal CTL1 outputted from the controller 12 shown in FIG. 19 is of an H level, the transmission gate TG4 is brought to an ON state and the transistor Q58 is brought to an OFF state. As a result, a current corresponding to the bias voltage VR4 flows through the transistor Q57. Thus, a mixed signal of the local oscillation signal LO_I and I signal BB_I is outputted between nodes ND12 and ND13. On the other hand, when the control signal CTL1 is of an L level, the transmission gate TG4 is brought to an OFF state and the transistor Q58 is brought to an ON state. As a result, since the transistor Q57 is brought to an OFF state, the mixed signal of the local oscillation signal LO_I and the I signal BB_I is not outputted between the nodes ND12 and ND13.

Similarly, a predetermined bias voltage VR5 is applied to a gate of the transistor Q67 for a current source via the transmission gate TG5, and the gate thereof is grounded via the transistor Q68. A control signal CTL2 is inputted to a gate electrode of an NMOS transistor that configures the transmission gate TG5, and a signal /CTL2 obtained by inverting the control signal CTL2 is inputted to a gate electrode of a PMOS transistor that configures the transmission gate TG5. The signal /CTL2 is inputted to a gate electrode of the NMOS transistor Q68.

Thus, when the control signal CTL2 outputted from the controller 12 shown in FIG. 19 is of an H level, the transmission gate TG5 is brought to an ON state and the transistor Q68 is brought to an OFF state. As a result, a current corresponding to the bias voltage VR5 flows through the transistor Q67. Thus, a mixed signal of the local oscillation signal LO_I and I signal BB_I is outputted between the nodes ND12 and ND13. On the other hand, when the control signal CTL2 is of an L level, the transmission gate TG5 is brought to an OFF state and the transistor Q68 is brought to an ON state. As a result, since the transistor Q67 becomes an OFF state, the mixed signal of the local oscillation signal LO_I and the I signal BB_I is not outputted between the nodes ND12 and ND13.

The resistive elements R6 and R7 that configure the adder 36 are used as load resistors common to the mixers 34A and 35A. Thus, when the control signals CTL1 and CTL2 are both H in level, an ac signal component outputted from between the nodes ND12 and ND13 becomes a signal obtained by adding the ac signal outputted from the mixer 34A and the ac signal outputted from the mixer 35A. When only the control signal CTL1 is of the H level, an ac signal component outputted from between the nodes ND12 and ND13 becomes the ac signal outputted from the mixer 34A. When only the control signal CTL2 is of the H level, an ac signal component outputted from between the nodes ND12 and ND13 becomes the ac signal outputted from the mixer 35A.

The current adjustment unit 49 shown in FIG. 20 is provided to control or adjust DC voltage levels at the nodes ND12 and ND13. In the current adjustment unit 49, the constant current source CS1 is coupled between the node ND12 and a ground line GND, and the constant current source CS2 is coupled between the node ND13 and the ground line GND. The constant current sources CS1 and CS2 respectively have control terminals and adjust output currents according to a bias voltage VR6 externally supplied to the control terminals through the transmission gate TG6. Assuming that a current flowing through each of the transistors Q57 and Q67 when the control signals CTL1 and CTL2 are both of the H level, is Io, the bias voltage VR6 is adjusted in such a manner that a current of Io/2 is outputted from each of the constant current sources CS1 and CS2. The control terminals of the constant current sources CS1 and CS2 are further coupled to the ground line GND through the transistor Q70.

The NAND circuit 47 of the current adjustment unit 49 outputs a result of NAND operation on the control signals CTL1 and CTL2 outputted from the controller 12 of FIG. 19 as a control signal CTL6. The control signal CTL6 becomes an H level when one of the control signals CTL1 and CTL2 is H in level and the other thereof is L in level. When the control signals CTL1 and CTL2 are both H in level, the control signal CTL6 becomes an L level. The control signal CTL6 is inputted to a gate electrode of an NMOS transistor that configure the transmission gate TG6, whereas a signal /CTL6 obtained by inverting the control signal CTL6 is inputted to a gate electrode of a PMOS transistor thereof. The inverted signal /CTL6 is inputted to a gate electrode of the NMOS transistor Q70.

When the control signals CTL1 and CTL2 are of the H and L levels respectively, the magnitude of the current flowing through the transistor Q57 is Io and the transistor Q67 is brought to the OFF state, so that no current flows therethrough. Since the control signal CTL6 is of an H level at this time, the current flowing through each of the constant current sources CS1 and CS2 is Io/2. As a result, the sum of the currents flowing through the resistive elements R6 and R7 respectively becomes 2×Io and becomes equal to the current flowing in a transmission mode (when the control signals CTL1 and CTL2 are both of the H level). Namely, since the DC voltage levels at the nodes ND12 and ND13 become equal to each other in the transmission and calibration modes, the calibration can be performed correctly.

### Fourth Embodiment

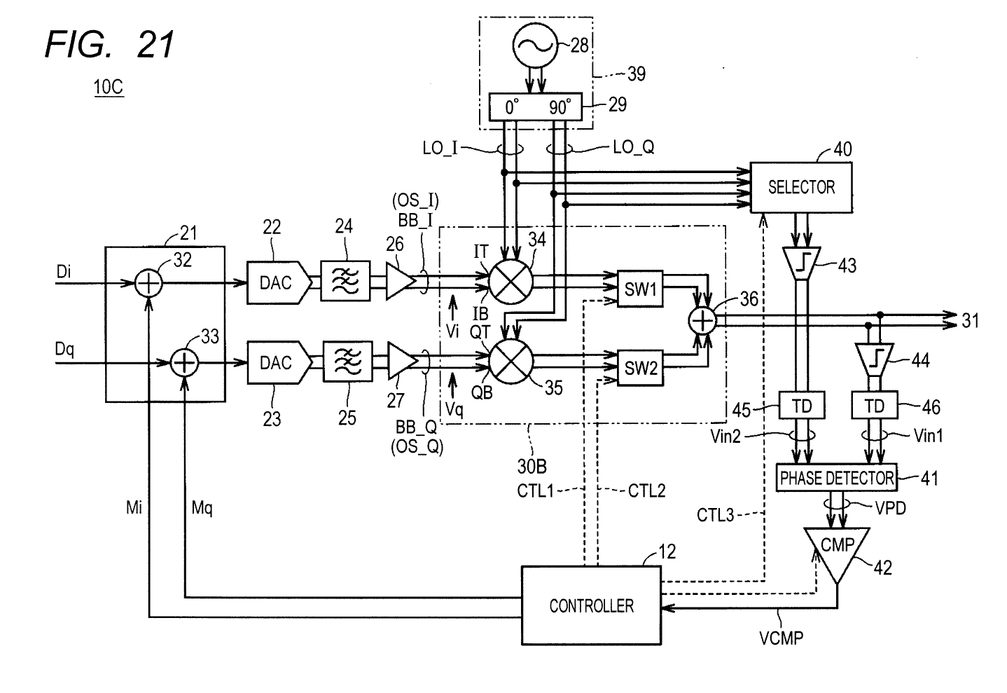

FIG. 21 is a block diagram showing a portion related to a DC offset correction, of an RFIC 10C according to a fourth embodiment of the present invention.

An orthogonal modulation unit 30B of the RFIC 10C shown in FIG. 21 is different from the orthogonal modulation unit 30 shown in FIG. 16 in that switches SW1 and SW2 are respectively provided on paths for mixed signals lying between mixers 34 and 35 and an adder 36 without being provided on paths for local oscillation signals LO_I and LO_Q, lying between a local signal generation unit 39 and the mixers 34 and 35. Since the RFIC 10C shown in FIG. 21 is identical to the RFIC 10A shown in FIG. 16 in other respects, the same or corresponding parts are identified by the same reference numerals, and their explanations will not be repeated.

The switches SW1 and SW2 are both controlled to be brought to an ON state at transmission. In this case, an ac signal obtained by mixing an I signal BB_I and the local oscillation signal LO_I by the mixer 34, and an ac signal obtained by mixing a Q signal BB_Q and the local oscillation signal LO_Q by the mixer 35 are added together by the adder 36 to generate a transmit signal.

During calibration, the switch SW1 is brought to the ON state and the switch SW2 is brought to an OFF state, so that a signal obtained by mixing an offset correction signal OS_I and the local oscillation signal LO_I by the mixer 34 is outputted from the adder 36. When the switch SW1 is brought to an OFF state and the switch SW2 is brought to the ON state in reverse, a signal obtained by mixing an offset correction signal OS_Q and the local oscillation signal LO_Q by the mixer 35 is outputted from the adder 36. When both of the switches SW1 and SW2 are in the ON state, the ac signals outputted from the mixers 34 and 35 are added together by the adder 36 and outputted therefrom.

Accordingly, the orthogonal modulation unit 30B is functionally identical to the orthogonal modulation units 30 employed in the first and second embodiments. It is therefore possible to perform a DC offset correction in accordance with a procedure similar to that employed in each of the first and second embodiments. As a result, a DC offset correction with a degree of accuracy higher than conventional can be carried out in a manner similar to the cases of the first and second embodiments.

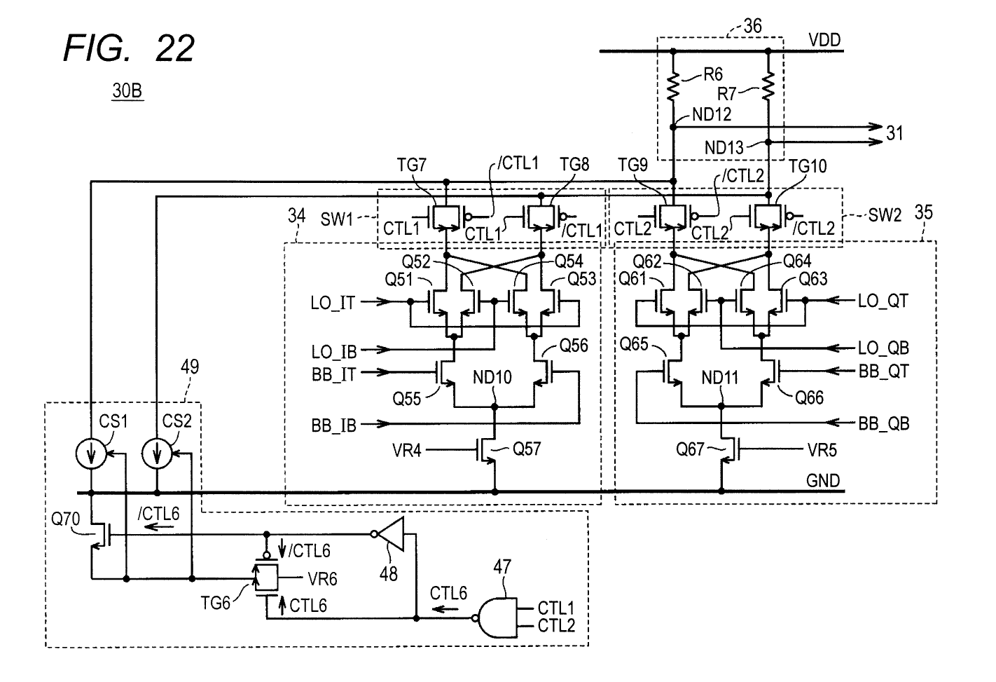

FIG. 22 is a circuit diagram showing one example of a configuration of the orthogonal modulation unit 30B shown in FIG. 21. Referring to FIG. 22, the orthogonal modulation unit 30B includes a current adjustment unit 49 in addition to the mixers 34 and 35, switches SW1 and SW2 and adder 36 shown in FIG. 21. The mixers 34 and 35 and adder 36 shown in FIG. 22 are identical in configuration to those shown in FIG. 13. Further, the current adjustment unit 49 shown in FIG. 22 is identical in configuration to that shown in FIG. 20. Accordingly, the same or corresponding parts are denoted by like reference numerals, and the description of their configurations will not be repeated.

The switch SW1 includes transmission gates TG7 and TG8. The transmission gate TG7 is provided between drains of transistors Q51 and Q54 and a node ND12. The transmission gate TG8 is provided between drains of transistors Q52 and Q53 and a node ND13. A control signal CTL1 is inputted to gate electrodes of NMOS transistors that configure the transmission gates TG7 and TG8 respectively. A signal /CTL1 obtained by inverting the control signal CTL1 is inputted to gate electrodes of PMOS transistors thereof.

Thus, when the control signal CTL1 outputted from a controller 12 shown in FIG. 21 is of an H level, the transmission gates TG7 and TG8 are respectively brought to an ON state. As a result, a signal obtained by mixing the local oscillation signal LO_I and the I signal BB_I with each other is outputted between the nodes ND12 and ND13. On the other hand, when the control signal CTL1 is of an L level, the transmission gates TG7 and TG8 are respectively brought to an OFF state, so that the signal obtained by mixing the local oscillation signal LO_I and the I signal BB_I with each other is not outputted between the nodes ND12 and ND13.

Similarly, the switch SW2 includes transmission gates TG9 and TG10. The transmission gate TG9 is provided between drains of transistors Q61 and Q64 and the node ND12. The transmission gate TG10 is provided between drains of transistors Q62 and Q63 and the node ND13. A control signal CTL2 is inputted to gate electrodes of NMOS transistors that configure the transmission gates TG9 and TG10 respectively. A signal /CTL2 obtained by inverting the control signal CTL2 is inputted to gate electrodes of PMOS transistors thereof.

Thus, when the control signal CTL2 outputted from the controller 12 shown in FIG. 21 is of an H level, the transmission gates TG9 and TG10 are respectively brought to an ON state. As a result, a signal obtained by mixing the local oscillation signal LO_Q and the Q signal BB_Q with each other is outputted between the nodes ND12 and ND13. On the other hand, when the control signal CTL2 is of an L level, the transmission gates TG9 and TG10 are respectively brought to an OFF state, so that the signal obtained by mixing the local oscillation signal LO_Q and the Q signal BB_Q with each other is not outputted between the nodes ND12 and ND13.

### Fifth Embodiment

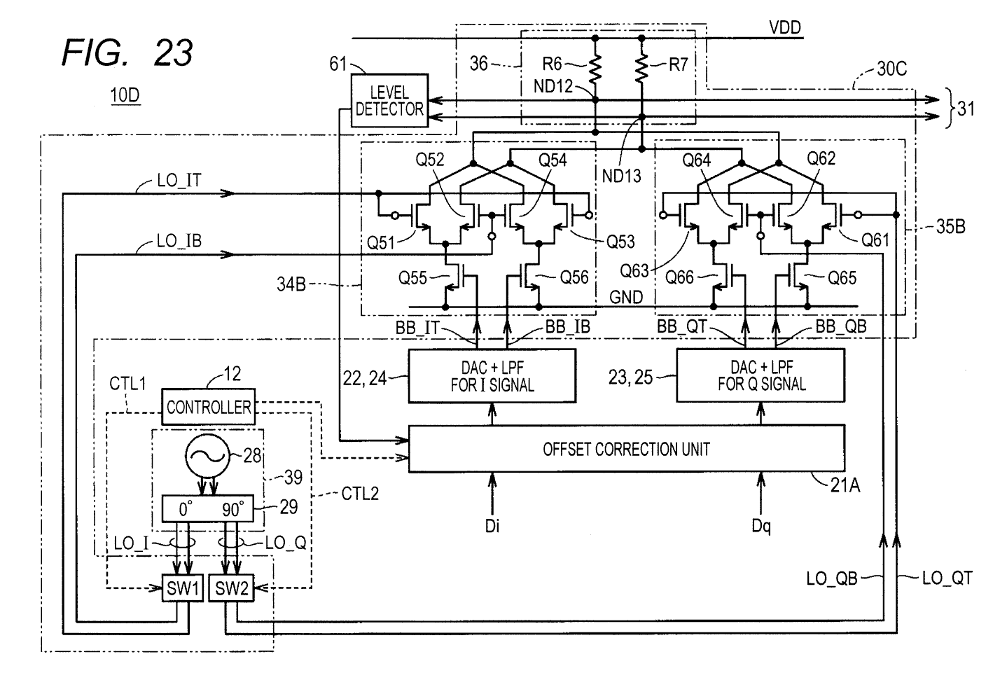

FIG. 23 is a block diagram showing a portion related to a DC offset correction, of an RFIC 10D according to a fifth embodiment of the present invention. The RFIC 10D shown in FIG. 23 is different from the RFICs 10, 10A, 10B and 10C according to the first through fourth embodiments in terms of a carrier leak detecting method. The carrier leak signal is detected by the phase detector 41 in the first through fourth embodiments, but a signal level of a carrier leak signal is directly detected by a level detector 61 in the RFIC 10D shown in FIG. 23. A concrete configuration of the RFIC 10D will be explained below.

Referring to FIG. 23, the RFIC 10D includes a local signal generation unit 39, digital-to-analog converters 22 and 23, low-pass filters 24 and 25, an orthogonal modulation unit 30C, the level detector 61, an offset correction unit 21A, and a controller 12. Since the local signal generation unit 39, digital-to-analog converters 22 and 23 and low-pass filters 24 and 25 are the same as those employed in the first through fourth embodiments, their explanations are not repeated.

The orthogonal modulation unit 30C shown in FIG. 23 includes mixers 34B and 35B, an adder 36, and switches SW1 and SW2. They are identical to those employed in the RFICs 10 and 10A according to the first embodiment in configuration and operation.

In particular, a circuit example in which a Gilbert cell circuit is used for the mixers 34B and 35B and the adder 36, is shown in FIG. 23. Since the circuit example shown in FIG. 23 is approximately identical to the configuration of the mixers 34 and 35 and adder 36 described in FIG. 13, the same or corresponding parts are identified by like reference numerals, and their explanations are not repeated. The mixers 34B and 35B shown in FIG. 23 differ from the mixers 34 and 35 shown in FIG. 13 in that they do not include the transistors Q57 and Q67 respectively. In FIG. 23, sources of transistors Q55, Q56, Q65 and Q66 are directly coupled to a ground line GND.

The level detector 61 detects the level of each of high-frequency signals outputted to output nodes ND12 and ND13 of the adder 36. The detected signal level is outputted to the offset correction unit 21A.

The offset correction unit 21A outputs a DC offset correction value for an I signal and a DC offset correction value for a Q signal to the orthogonal modulation unit 30C during calibration. At this time, the offset correction unit 21A adjusts the magnitude of each DC offset correction value in accordance with a command issued from the controller 12 in such a manner that the signal level detected by the level detector 61 reaches a minimum. At transmission, the offset correction unit 21A adds the offset correction value adjusted during calibration to each of the input I signal Di and Q signal Dq and outputs the same therefrom.

During calibration, the controller 12 brings the switches SW1 and SW2 to an ON or OFF state. Since a concrete method for controlling the switches SW1 and SW2 is similar to the first and second embodiments, its detailed description is not repeated. Each of the DC offset correction values Mi and Mq is increased or decreased according to the positive and negative of the output voltage of the phase detector 41 in the first and second embodiments (refer to Steps S5 and S10 shown in FIG. 10 and Steps S5, S10, S15 and S20 shown in FIG. 18), whereas in the fifth embodiment, the DC offset correction values Mi and Mq are increased or decreased in such a manner that the signal level detected by the level detector 61 is brought to the minimum. In the fifth embodiment as well, a high-accuracy DC offset correction is enabled in a manner similar to the first and second embodiments.

The embodiments disclosed this time are to be considered in all respects as illustrative and not restrictive. The scope of the invention is indicated by the appended claims rather than by the foregoing description, and all changes that come within the meaning and range of the claims and equivalency thereof are intended to be embraced therein.

What is claimed is:

1. A communication apparatus having a transmission mode and a calibration mode as operation modes, comprising:
a local signal generation unit which generates first and second local oscillation signals different in phase from each other by 90°;
a first switch which receives the first local oscillation signal therein and outputs the first local oscillation signal when a first control signal is activated;
a second switch which receives the second local oscillation signal therein and outputs the second local oscillation signal when a second control signal is activated;
a first mixer which has a first input part and which multiplies a signal inputted to the first input part and an ac signal component outputted from the first switch by each other and outputs a result of multiplication therefrom;
a second mixer which has a second input part and which multiplies a signal inputted to the second input part and an ac signal component outputted from the second switch by each other and outputs a result of multiplication therefrom,
the first input part being inputted with a first offset correction signal under adjustment in the calibration mode, and inputted with a first baseband signal added with the post-adjustment first offset correction signal in the transmission mode,
the second input part being inputted with a second offset correction signal under adjustment in the calibration mode, and inputted with a second baseband signal added with the post-adjustment second offset correction signal in the transmission mode;
an adder which adds the ac signal components outputted from the first and second mixers and outputs a result of addition therefrom; and
a controller which outputs the first and second control signals and adjusts the first and second offset correction signals, based on the output signal of the adder in the calibration mode, wherein the controller activates at least one of the first and second control signals in the calibration mode.

2. A communication apparatus having a transmission mode and a calibration mode as operation modes, comprising:
a local signal generation unit which generates first and second local oscillation signals different in phase from each other by 90°;
a first mixer which has a first input part and which is brought to an operating state when a first control signal is activated, to thereby mix a signal inputted to the first input part and the first local oscillation signal with each other and output a result of mixing therefrom;
a second mixer which has a second input part and which is brought to an operating state when a second control signal is activated, to thereby mix a signal inputted to the second input part and the second local oscillation signal with each other and output a result of mixing therefrom,
the first input part being inputted with a first offset correction signal under adjustment in the calibration mode, and inputted with a first baseband signal added with the post-adjustment first offset correction signal in the transmission mode,
the second input part being inputted with a second offset correction signal under adjustment in the calibration mode, and inputted with a second baseband signal added with the post-adjustment second offset correction signal in the transmission mode;
an adder which adds the ac signal components outputted from the first and second mixers and outputs a result of addition therefrom; and
a controller which outputs the first and second control signals and adjusts the first and second offset correction signals, based on the output signal of the adder in the calibration mode, wherein the controller activates at least one of the first and second control signals in the calibration mode.

3. A communication apparatus having a transmission mode and a calibration mode as operation modes, comprising:
a local signal generation unit which generates first and second local oscillation signals different in phase from each other by 90°;
a first mixer which has a first input part and which mixes a signal inputted to the first input unit and the first local oscillation signal with each other and outputs a result of mixing therefrom;
a second mixer which has a second input part and which mixes a signal inputted to the second input part and the second local oscillation signal with each other and outputs a result of mixing therefrom,
the first input part being inputted with a first offset correction signal under adjustment in the calibration mode, and inputted with a first baseband signal added with the post-adjustment first offset correction signal in the transmission mode,
the second input part being inputted with a second offset correction signal under adjustment in the calibration mode, and inputted with a second baseband signal added with the post-adjustment second offset correction signal in the transmission mode;
a first switch which receives the output signal of the first mixer therein and outputs the output signal of the first mixer when a first control signal is activated;
a second switch which receives the output signal of the second mixer therein and outputs the output signal of the second mixer when a second control signal is activated;
an adder which adds the ac signal components outputted from the first and second switches; and
a controller which outputs the first and second control signals and adjusts the first and second offset correction signals, based on the output signal of the adder in the calibration mode, wherein the controller activates at least one of the first and second control signals in the calibration mode.

4. The communication apparatus according to claim 1, further including a phase detector which detects a difference in phase between the output signal of the adder and the signal selected by the controller, of the first and second local oscillation signals,
wherein the controller adjusts the first and second offset correction signals, based on the phase difference detected by the phase detector in the calibration mode.

5. The communication apparatus according to claim 4, wherein when the magnitude of the first offset correction signal is changed in the calibration mode in a state in which the first control signal is activated and the second control signal is inactivated, the controller monitors a difference in phase between the output signal of the adder and the selected first local oscillation signal through the phase detector, and determines the first offset correction signal at the time that the monitored phase difference is changed by 180°, as the post-adjustment first offset correction signal used in the transmission mode, and
wherein when the magnitude of the second offset correction signal is changed in the calibration mode in a state in which the first control signal is inactivated and the second control signal is activated, the controller monitors a difference in phase between the output signal of the adder and the selected second local oscillation signal through the phase detector, and determines the second offset correction signal at the time that the monitored phase difference is changed by 180°, as the post-adjustment second offset correction signal used in the transmission mode.

6. The communication apparatus according to claim 4,
wherein when the magnitude of the first offset correction signal is changed in the calibration mode in a state in which the first control signal is activated and the second control signal is inactivated, the controller monitors a difference in phase between the output signal of the adder and the selected first local oscillation signal through the phase detector, and determines the first offset correction signal at the time that the monitored phase difference is changed by 180°, as a first temporary correction signal,
wherein when the magnitude of the second offset correction signal is changed in the calibration mode in a state in which the first control signal is inactivated and the second control signal is activated, the controller monitors a difference in phase between the output signal of the adder and the selected second local oscillation signal through the phase detector, and determines the second offset correction signal at the time that the monitored phase difference is changed by 180°, as a second temporary correction signal,
wherein when the second offset correction signal is fixed to the second temporary correction signal and the first offset correction signal is further changed from the first temporary correction signal in the calibration mode in a state in which the first and second control signals are both activated, the controller monitors a difference in phase between the output signal of the adder and the selected first local oscillation signal through the phase detector, and determines the first offset correction signal at the time that the monitored phase difference is changed by 180°, as the post-adjustment first offset correction signal used in the transmission mode, and
wherein when the first offset correction signal is fixed to a post-adjustment value thereof and the second offset correction signal is further changed from the second temporary correction signal in the calibration mode in a state in which the first and second control signals are both activated, the controller monitors a difference in phase between the output signal of the adder and the selected second local oscillation signal through the phase detector, and determines the second offset correction signal at the time that the monitored phase difference is changed by 180°, as the post-adjustment second offset correction signal used in the transmission mode.

7. The communication apparatus according to claim 1, further including a level detector which detects a level of an output signal of the adder,
wherein the controller adjusts the first and second offset correction signals, based on the signal level detected by the level detector in the calibration mode.

8. The communication apparatus according to claim 7, wherein when the magnitude of the first offset correction signal is changed in the calibration mode in a state in which the first control signal is activated and the second control signal is inactivated, the controller monitors a level of an output signal of the adder through the level detector, and determines the first offset correction signal at the time that the monitored signal level is minimized, as the post-adjustment first offset correction signal used in the transmission mode, and
wherein when the magnitude of the second offset correction signal is changed in the calibration mode in a state in which the first control signal is inactivated and the second control signal is activated, the controller monitors a level of an output signal of the adder through the level detector, and determines the second offset correction signal at the time that the monitored signal level is minimized, as the post-adjustment second offset correction signal used in the transmission mode.

9. The communication apparatus according to claim 7,
wherein when the magnitude of the first offset correction signal is changed in the calibration mode in a state in which the first control signal is activated and the second control signal is inactivated, the controller monitors a level of an output signal of the adder through the level detector, and determines the first offset correction signal at the time that the monitored signal level is minimized, as a first temporary correction signal,
wherein when the magnitude of the second offset correction signal is changed in the calibration mode in a state in which the first control signal is inactivated and the second control signal is activated, the controller monitors a level of an output signal of the adder through the level detector, and determines the second offset correction signal at the time that the monitored signal level is minimized, as a second temporary correction signal,
wherein when the second offset correction signal is fixed to the second temporary correction signal and the first offset correction signal is further changed from the first temporary correction signal in the calibration mode in a state in which the first and second control signals are both activated, the controller monitors a level of an output signal of the adder through the level detector, and determines an offset correction signal at the time that the monitored signal level is brought to a minimum, as the post-adjustment first offset correction signal used in the transmission mode, and
wherein when the first offset correction signal is fixed to a post-adjustment value thereof and the second offset correction signal is further changed from the second temporary correction signal in the calibration mode in a state in which the first and second control signals are both activated, the controller monitors a level of an output signal of the adder through the level detector, and determines the second offset correction signal at the time that the monitored signal level is brought to a minimum, as the post-adjustment second offset correction signal used in the transmission mode.

10. The communication apparatus according to claim 2, further including a phase detector which detects a difference in phase between the output signal of the adder and the signal selected by the controller, of the first and second local oscillation signals,
wherein the controller adjusts the first and second offset correction signals, based on the phase difference detected by the phase detector in the calibration mode.

11. The communication apparatus according to claim 2, further including a level detector which detects a level of an output signal of the adder,
wherein the controller adjusts the first and second offset correction signals, based on the signal level detected by the level detector in the calibration mode.

12. The communication apparatus according to claim 3, further including a phase detector which detects a difference in phase between the output signal of the adder and the signal selected by the controller, of the first and second local oscillation signals,
wherein the controller adjusts the first and second offset correction signals, based on the phase difference detected by the phase detector in the calibration mode.

13. The communication apparatus according to claim 3, further including a level detector which detects a level of an output signal of the adder,
wherein the controller adjusts the first and second offset correction signals, based on the signal level detected by the level detector in the calibration mode.
